(19) United States
(12) Patent Application Publication
(10) Pub. No.: US 2026/0312040 A1
(43) Pub. Date: Oct. 8, 2026

(54) POSITIVE ELECTRODES FOR RECHARGEABLE BATTERIES

(71) Applicant: BOARD OF REGENTS, THE UNIVERSITY OF TEXAS SYSTEM, Austin, TX (US)

(72) Inventors: Arumugam MANTHIRAM, Austin, TX (US); Jiarui HE, Austin, TX (US); Amruth BHARGAV, Austin, TX (US)

(21) Appl. No.: 19/483,083

(22) PCT Filed: May 13, 2024
(86) PCT No.: PCT/US2024/029049

§ 371 Date: Nov. 10, 2025

Related U.S. Application Data
(60) Provisional application No. 63/564,029, filed on Mar. 12, 2024.

(30) Foreign Application Priority Data
May 11, 2023 (CN) 202310523783.0

(51) Int. Cl. H01M 4/58; H01M 4/02; H01M 4/04; H01M 4/36; H01M 4/38; H01M 4/62; H01M 10/0525; H01M 10/0568; H01M 10/0569

(52) U.S. Cl. CPC H01M 4/5815; H01M 4/0416; H01M 4/0471; H01M 4/364; H01M 4/381; H01M 4/625; H01M 10/0525; H01M 10/0568; H01M 10/0569; H01M 2004/028

(57) ABSTRACT

Disclosed herein is a cathode electrode for a reversible battery comprising an active material comprising an alkali metal ion or alkaline-earth metal ion and at least one or more transition metal chalcogenides, and wherein active redox species comprise anions. Also disclosed are secondary batteries comprising such cathode electrodes. Also disclosed are methods of making the disclosed herein cathode electrodes and secondary batteries.

### CROSS-REFERENCE TO RELATED APPLICATIONS

This application claims the benefit of priority to Chinese Application No. 202310523783.0, filed on May 11, 2023, and the benefit of U.S. Provisional Application No. 63/564,029, filed Mar. 12, 2024, the contents of which are incorporated herein by reference in their entirety.

### STATEMENT ACKNOWLEDGING GOVERNMENT SUPPORT

This invention was made with government support under Grant No. DE-S00005397 awarded by the Department of Energy. The government has certain rights in the invention.

### TECHNICAL FIELD

This application relates generally to positive electrodes in rechargeable batteries.

### BACKGROUND

It is one of the global strategies to avoid the energy crisis and environmental degradation by developing renewable, clean energy; rechargeable batteries are the core of renewable energy technologies and are broad in application, such as electric vehicles, large-scale energy storage systems, and some emerging applications requiring high-energy-density (such as electric aircraft and trucks). Lithium-ion batteries have always been dominant in the battery market with their characteristics of relatively high energy ratio, long service life, high-power tolerance, light weight, green and environmental protection, etc. However, the global demand for rechargeable batteries with high energy density has increased significantly, and thus, over-reliance on lithium-ion batteries is unrealistic due to high prices and scarcity of resources. To this end, it is necessary to turn to the exploration of novel battery systems to meet the enormous demand in the future.

For example, sodium-ion batteries (SIBs) or potassium-ion batteries are an exciting post-lithium energy storage alternative. In addition to abundant sodium resources and low cost, they also have a “rocking chair” mechanism similar to lithium-ion batteries, and the sodium-ion batteries (and potentially potassium-ion batteries) are recognized as ideal secondary batteries suitable for future low-speed electric vehicles and large-scale energy storage systems, etc.

However, existing sodium-ion battery positive electrode materials have many problems: low sodium storage capacity, poor long-term cycle stability and high-rate characteristics, high preparation costs, etc. It is one of the keys to the practical application of sodium-ion energy storage batteries to find low-cost sodium-ion battery positive electrode materials with excellent sodium storage performance.

Traditional sodium-ion battery positive electrode materials comprise, for example, layered transition metal oxides NaₓMO₂ (M is Mn, Fe, Co, Ni) and Mn, Fe cyanide or manganese- and iron-based coordinated Prussian blue or white compounds, polyanionic vanadium-based phosphates or pyrophosphates, etc. The positive electrode materials are charged and discharged based on a deintercalation reaction, resulting in an unstable structure of the materials in the charging and discharging process, which is prone to generate irreversible phase transitions and leads to low practical capacity.

On the other hand, for a novel sodium-sulfur battery system, there is an intermediate product, sodium polysulfide, which is easily dissolved in the electrolyte, causing a “shuttle effect” to occur, causing active substances to lose, thereby resulting in a short cycle life.

Thus, novel and suitable positive electrode materials with fast diffusion kinetics, excellent rate performance, and high energy density are needed. These needs and other needs are at least partially satisfied by the present disclosure.

### SUMMARY

The present disclosure is directed to a cathode electrode for a reversible battery comprising an active material comprising an alkali metal ion or alkaline-earth metal ion and at least one or more transition metal chalcogenides, and wherein active redox species comprise anions.

In still further aspects, the active material is represented by M¹M²X, wherein M¹ comprises Li, Na, K, or a combination thereof; wherein M² comprises at least one transition metal ion comprising Co, Fe, Mn, Ni, V, Ti, Cr, Cu, Zr, Nb, Ta, Mo, W, Pd, Pt, Re, Cd, or a combination thereof; wherein X comprises S, Se, Te, O, or a combination thereof; and wherein M¹, M², and X are present in a predetermined ratio.

In yet still further aspects, the active material further comprises Y and is represented by M¹M²XY, wherein Y comprises a halogen, and wherein M¹, M², X, and Y are present in a predetermined ratio.

In yet still further aspects, the active material is represented by Mₐ¹M_{b}²X_{c}Y_{d}, wherein M¹ is Na, 2≤a≤7, M² is one of Co, Fe, Mn, Ni, V, Ti, Cr, Cu, Zr, Nb, Ta, Mo, W, Pd, Pt, Re, Cd, or a combination thereof, wherein 0<b≤2; X is one or more of S, Se, Te, O, or a combination thereof, wherein 2<c≤5; and Y is a halogen, wherein 0≤d≤1.

Also disclosed herein is a secondary battery comprising any of the disclosed herein cathode electrodes. In still further aspects, the disclosed herein secondary batteries further comprise an anode electrode and an electrolyte.

In further aspects, disclosed herein is a method of making any of the disclosed herein cathode electrodes wherein the method comprises: a) forming a mixture comprising an alkali metal or an alkaline-earth metal, one or more transition metals, and a chalcogen-group element; (b) heating the mixture to form an active material represented by M¹M²X, wherein M¹ is an alkali metal ion or an alkali-earth metal ion, wherein M² comprises one or more transition metal ions, and wherein X comprises at least one chalcogen anion, and wherein M¹, M², and X are present in a predetermined ratio.

Still further disclosed herein are methods of making any of the secondary batteries disclosed herein.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1B show cathode design strategies. FIG. 1A shows an illustration of the advantages of anion-redox cathodes. FIG. 1B shows the comparative electrochemical performance of the reported cathodes for Na ion batteries.

FIGS. 2A-2E show the redox behavior of Na₆MS₄. FIG. 2A shows a crystal structure of Na₆CoS₄. FIG. 2B shows redox energies of the transition-metal ions with respect to the top of the S²⁻:2p band. FIG. 2C shows an evolution of pDOS with various transition metals. The Na, S, Zn, Mn, Co, and Fe projections are colored, respectively, in red, grey, light green, purple, blue, and yellow. FIG. 2D shows voltage profiles of the compositions synthesized vs. Na metal at a C/10 rate between 1.2 and 2.8 V in the first cycle. FIG. 2E shows an illustration of the structure of Na₆MS₄.

FIGS. 3A-3G show the SEM morphology of Na₆CoS₄@C (FIGS. 3A-3B). SEM of Na₆CoS₄@C with the corresponding elemental mapping images of C, Co, Na, and S (FIG. 3C).

FIG. 4 is an XRD pattern of Na₆CoS₄@C.

FIG. 5 is an XRD pattern of Na₆CoS₄@C prepared by the reported method with the reaction between S, Co, and Na₂CO₃ under an H₂ atmosphere at 725° C. for 3 h.

FIGS. 6A-6B show the SEM images of Na₆FeS₄@C at various magnifications.

FIG. 7 is the SEM images and corresponding elemental mapping of Na₆FeS₄@C.

FIG. 8 is an XRD pattern of Na₆FeS₄@C.

FIGS. 9A-9B show the SEM images of Na₆MnS₄@C at various magnifications.

FIG. 10 is the SEM images and corresponding elemental mapping of Na₆MnS₄@C.

FIG. 11 is an XRD pattern of Na₆MnS₄@C.

FIGS. 12A-12B show the SEM images of Na₆ZnS₄@C at various magnifications.

FIG. 13 is the SEM images and corresponding elemental mapping of Na₆ZnS₄@C.

FIG. 14 is an XRD pattern of Na₆ZnS₄@C.

FIGS. 15A-15G show the electrochemical behavior of Na₆CoS₄@C. FIG. 15A—Long-term cycling performance of Na₆MS₄@C cathodes. FIG. 15B—The corresponding discharge/charge voltage profiles of Na₆CoS₄@C cathode. FIG. 15C-Rate performance of Na₆CoS₄@C cathode at various C rates. FIG. 15D—Cycling performance of Na₆CoS₄@C coin cell with a high active material loading (5 mg cm⁻²). Cycling performances of Na₆CoS₄@C pouch cell with FIG. 15E—a low active material loading and FIG. 15F—a high active material loading and lean electrolyte conditions. FIG. 15G—Cycling performances of anode-free Ni∥Na₆CoS₄@C cell.

FIG. 16 shows the CV curves of Na₆CoS₄@C cathode at 0.1 mV s⁻¹ in a potential window from 1.2 to 2.8 V.

FIGS. 17A-17D illustrate the behavior of Na₆CoS₄@C. FIG. 17A—Charge and discharge curves of a Na₆CoS₄@C coin cell in the initial cycle and FIG. 17B—the corresponding diffraction patterns. FIG. 17C—CV curves of a Na₆CoS₄@C coin cell in the first two cycles and FIG. 17D—the corresponding time sequence of Raman spectra.

FIGS. 18A-18F show the characterizations of cycled Na₆CoS₄@C. FIG. 18A—High-resolution TEM images of fresh Na₆CoS₄@C, FIGS. 18B-18D—fully charged Na₆CoS₄@C, and FIG. 18E—fully discharged Na₆CoS₄@C. FIG. 18F—S 2p spectra of the fresh, fully charged, and fully discharged Na₆CoS₄@C cathode.

FIG. 19 shows the Co 2p spectra of the fresh, fully charged, and fully discharged Na₆CoS₄@C cathode.

FIG. 20 shows the high-resolution TEM images of Na₆CoS₄@C at a fully discharged state.

FIG. 21 shows the TEM images of Na₆CoS₄@C at the initial state and the corresponding elemental mapping images of C, Na, S, and Co.

FIG. 22 shows the TEM images of Na₆CoS₄@C at a fully discharged state and the corresponding elemental mapping images of C, Na, S, and Co.

FIG. 23 shows a schematic of the conversion of Na₆CoS₄@C. A conversion from high crystallinity to an amorphous structure

FIG. 24 shows the cycling performance of the Na₆CoS₄@C coin cell in a low-concentration electrolyte of 1 M NaFSI in DME.

FIG. 25 shows the evolution of the pDOS of Na₆CoS₄ with Na extraction (charge).

FIG. 26 is a battery cycle performance diagram of the battery positive electrode Na₆CoS₄ in the present invention under a current density of 0.2 A/g.

FIG. 27 is a capacity-voltage curve diagram of a positive electrode material of the battery positive electrode Na₆CoS₄ in the present invention.

FIG. 28 is a battery cycle performance diagram of the battery positive electrode Na₆FeS₄ in the present invention under a current density of 0.2 A/g.

FIG. 29 is a capacity-voltage curve diagram of a positive electrode material of the battery positive electrode Na₆FeS₄ in the present invention.

FIG. 30 is a cycle performance diagram of a comparative example NaNi_{1/3}Fe_{1/3}Mn_{1/3}O₂ (NFM).

FIG. 31 is a capacity-voltage curve of the comparative example NaNi_{1/3}Fe_{1/3}Mn_{1/3}O₂ (NFM).

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a salt” includes two or more such salts and a reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

All disclosed values also include values that fall within ±10% variation from the disclosed value unless otherwise indicated or inferred. In other words, if a range of 1 to 10 is disclosed, then a range of about 1 to about 10 is disclosed. In such aspects, it is understood that the amount or value in question can be the exact value or a value that provides equivalent results or effects as recited in the claims or taught herein. That is, amounts, sizes, formulations, parameters, and other quantities and characteristics include both exact values but also approximate, larger or smaller values as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘x, y, z, or less’ and should be interpreted to include the specific ranges of ‘x,’ ‘y,’ ‘z,’ ‘about x,’ ‘about y,’ and ‘about z’ as well as the ranges of ‘less than x,’ ‘less than y, or ‘less than z,’ or ‘less than about x,’ ‘less than about y, and ‘less than about z.’ Likewise, the phrase ‘x, y, z, or greater’ should be interpreted to include the specific ranges of ‘x,’ ‘y,’ ‘z,’ ‘about x,’ ‘about y,’ and ‘about z’ as well as the ranges of ‘greater than x,’ greater than y,’ ‘greater than z,’ or ‘greater than about x,’ greater than about y,’ ‘greater than about z.’ In addition, the phrase “‘x’ to ‘y’,” where ‘x’ and ‘y’ are numerical values, also includes “about ‘x’ to about ‘y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5% but also include individual values (e.g., 1%, 2%, 3%, and 4%) and the sub-ranges (e.g., 0.5% to 1.1%; 5% to 2.4%; 0.5% to 3.2%, and 0.5% to 4.4%, and other possible sub-ranges) within the indicated range.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

In still further aspects, when the specific values are disclosed between two end values, it is understood that these end values can also be included.

In still further aspects, when the range is given, and exemplary values are provided, it is understood that any ranges can be formed between any exemplary values within the broadest range. For example, if individual numbers 1, 2, 3, 4, 5, 6, 7, etc. are disclosed, then the ranges 1-7, 2-7, 3-7, 4-7, 5-7, 6-7, 1-6, 1-5, 1-4, 1-3, 1-2, 2-6, 2-5, etc. are also disclosed.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Cathode Electrodes

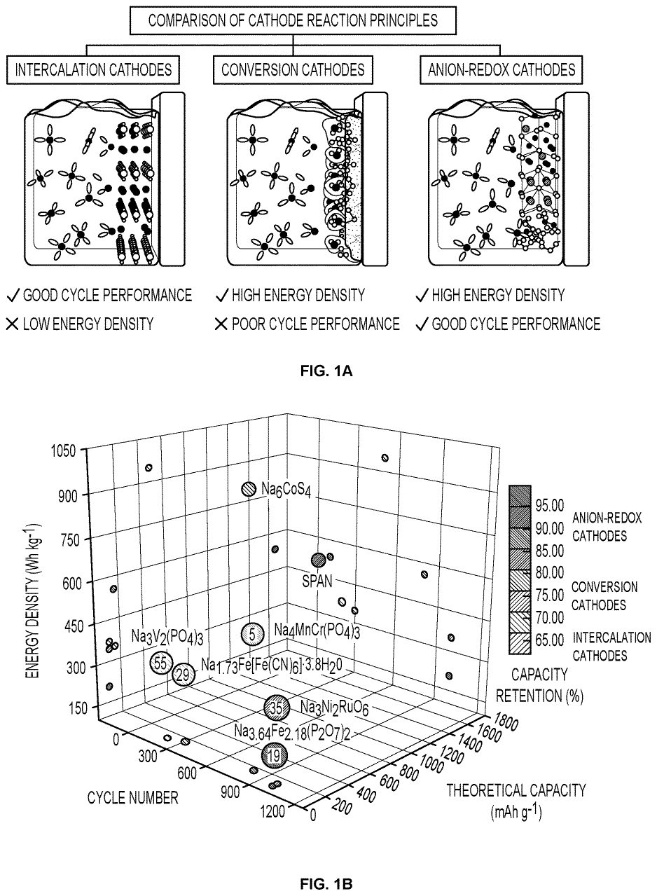

In the realm of energy storage, the rapid evolution of battery technologies has ignited a fervent quest for safer, more efficient, sustainable solutions (1-3). For battery chemistry to enter the market for energy storage applications like electric vehicles (EVs), they need to satisfy some critical parameters, such as an energy density of >150 Wh kg⁻¹ with >500 cycles. As lithium-ion batteries (LIBs) continue to dominate the market, concerns about the availability and cost of lithium resources have spurred interest in alternative battery chemistries. Among the emerging contenders, sodium-ion batteries (SIBs) have recently crossed this threshold and have begun to be employed in EVs due to their potential to offer performance comparable to lithium-ion batteries while utilizing more abundant sodium resources (4-6). The cathode, a pivotal component of SIBs, plays a crucial role in determining the overall performance and characteristics of the batteries. For many years, cathode materials for SIBs mainly relied solely on transition metal (cationic) redox, resulting in a limited capacity and energy density (FIG. 1A). Therefore, it is critical to look into approaches that can significantly enhance the energy density and lifespan of SIBs.

In recent years, the sulfur cathode with a conversion redox reaction has emerged as a potential candidate for high-energy-density SIBs. However, such cathodes with a conversion redox suffer from unstable redox chemistry during the conversion, including the polysulfide shuttling effect, leading to a limited lifespan. Apart from classical intercalation chemistry and conversion chemistry, there are materials that are a hybrid, i.e., anionic-redox materials. There has been immense interest in recent years in anionic redox in LIBs with the electrochemical participation of sulfur to offer higher capacities, such as Li-rich layered sulfides Li_{1.33}Ti_{0.57}Fe_{0.3}S₂ (7). It has been shown that FeSₓ and MoSₓ can undergo anion redox. However, these materials do not contain sodium and thus (or any other alkali metal) would necessitate pairing them with a Na-metal anode (or other corresponding alkali-metal anode), which is known to have poor reversibility. Therefore, it is preferable to have a cathode that contains sodium (or other alkali metals as disclosed herein) in it as it can allow the use of traditional anodes like hard carbon or even anode-free cell designs. An early effort by Shadike and co-workers reported reversible S²⁻/S₂²⁻ redox in layered O3-type NaCrS₂ cathode (8), which delivers a capacity of 103 mAh g⁻¹. NaCrS₂ with anionic sulfur redox provides new insights to bring forth high-capacity cathodes for SIBs. In such materials, sulfur exists fully or partially as dimerized S⁻—S⁻ (or S₂²⁻) pairs that break into the standard S²⁻ state upon electrochemical insertion of Na (FIG. 1B). However, the anionic redox activity is only partly reversible in such materials, resulting in rapid capacity fade (9). Therefore, there is much appetite to develop stable cathodes with high capacities for SIBs, potentially involving anionic redox.

In certain aspects, disclosed herein are novel cathode electrode materials that are shown to overcome these deficiencies.

In certain aspects, disclosed herein is a cathode electrode for a reversible battery comprising an active material comprising an alkali metal ion or alkaline-earth metal ion and at least one or more transition metal chalcogenides, and wherein active redox species comprise anions. Yet, in other aspects, the active redox species are substantially anions. Yet, in other aspects, the active redox species are anions.

In certain aspects, the anion redox species comprise chalcogen anion.

In certain aspects, the active material comprises an alkali metal ion and at least one or more transition metal chalcogenides. In other aspects, the active material comprises an alkaline-earth metal ion and at least one or more transition metal chalcogenides. In yet other aspects, the active material can comprise an alkali metal ion and at least one or more transition metal chalcogenides doped with an alkaline-earth metal. In still further aspect, when the alkaline-earth metal is a dopant, it can be present in an amount of about 0.1 to about 45 wt %, including exemplary values of about 0.5 wt %, about 1 wt %, about 5 wt %, about 10 wt %, about 15 wt %, about 20 wt %, about 25 wt %, about 30 wt %, about 35 wt %, and about 40 wt %. It is understood that the dopant can be present in any amount that falls between any two foregoing values, or it can fall in any range formed by any two foregoing values. For example, and without limitations, the dopant can be present in an amount of about 0.1 to about 43 wt %, about 0.1 to about 40 wt %, about 0.1 to about 30 wt %, about 0.1 to about 20 wt %, about 0.1 to about 10 wt %, about 0.1 to about 5 wt %, about 0.1 to about 1 wt %, about 0.1 to about 0.5 wt %, and so on.

In still further aspects, the active material is substantially crystalline. Yet in still further aspects, the active material is crystalline.

In still further aspects, the active material can be represented by M¹M²X. In such exemplary aspects, M¹ represents the working/stored/active ion(s) containing a positive charge, M² is the structural ion(s) containing a positive charge, and X is the counter ion which starts with a negative charge but undergoes redox (change in charge) as M¹ is inserted/removed from the structure. In yet still further aspects, M¹ is an alkali or an alkaline-earth metal ion. In yet still further aspects, M¹ comprises Li, Na, K, or a combination thereof. Yet in still further aspects, M¹ can be Ca, Mg, or a combination thereof. In still further aspects M² comprises at least one transition metal ion. In such exemplary and unlimiting aspects, M² can comprise Co, Fe, Mn, Ni, V, Ti, Cr, Cu, Zr, Nb, Ta, Mo, W, Pd, Pt, Re, Cd, or a combination thereof. In still further aspects, X comprises a chalcogen ion. For example, and without limitations, wherein X can comprise S, Se, Te, O, or a combination thereof. In still further aspects, M¹, M², and X are present in a predetermined ratio.

In still further aspects, the active material can further comprise Y and is represented by M¹M²XY, wherein Y comprises a halogen and wherein M1, M2, X, and Y are present in a predetermined ratio. It is understood that in these exemplary aspects, Y is the supporting ion with a negative charge that may or may not undergo redox.

In certain aspects, and as disclosed above, the active material can further comprise a dopant. In such exemplary and unlimiting aspects, M² comprises a dopant comprising one or more of, but not limited to, Mg, Ba, Ca, Sr, Al, B, Ga, Si, Ge, As, Zn, Sn, Sb, In, or any combination thereof. In still further aspects, the dopant can be present in an amount of about 0.1 to about 45 wt %, including exemplary values of about 0.5 wt %, about 1 wt %, about 5 wt %, about 10 wt %, about 15 wt %, about 20 wt %, about 25 wt %, about 30 wt %, about 35 wt %, and about 40 wt %. It is understood that the dopant can be present in any amount that falls between any two foregoing values, or it can fall in any range formed by any two foregoing values. For example, and without limitations, the dopant can be present in an amount of about 0.1 to about 43 wt %, about 0.1 to about 40 wt %, about 0.1 to about 30 wt %, about 0.1 to about 20 wt %, about 0.1 to about 10 wt %, about 0.1 to about 5 wt %, about 0.1 to about 1 wt %, about 0.1 to about 0.5 wt %, and so on.

In still further aspects, the active material is represented by Mₐ¹M_{b}²X_{c}Y_{d}. In certain exemplary and unlimiting aspects, M¹ can be Na (but it is understood that it can also be Li, K, Ca, or Mg or combinations thereof) and 2≤a≤7, including exemplary values of about 2, about 2.1, about 2.5, about 2.7, about 3, about 3.2, about 3.5, about 3.7, about 4, about 4.2, about 4.5, about 4.7, about 5, about 5.2, about 5.5, about 5.7, about 6, about 6.2, about 6.5, about 6.7, and about 7. In still further aspects, a can have a value that falls within any range formed by the mentioned above values, for example, it can be in a range of about 2.1-about 6.9, about 2.5-about 6.3, about 2-about 6, about 3-about 7, about 3-about 6, about 4-about 7, about 2-about 6.4, and so on.

In further aspects, M² is one of Co, Fe, Mn, Ni, V, Ti, Cr, Cu, Zr, Nb, Ta, Mo, W, Pd, Pt, Re, Cd, or a combination thereof, 0<b≤2, including exemplary values of about 0.01, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, and about 2. In still further aspects, b can have a value that falls within any range formed by the mentioned above values, for example, it can be in a range of about 0.01-about 2, about 0.1-about 2, about 0.5-about 2, about 0.7-about 2, about 1-about 2, about 1.2-about 2, about 1.5-about 2, and so on.

In still further aspects, X is one or more of S, Se, Te, O, or a combination thereof and 2<c≤5, including exemplary values of about 2.01, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.1, about 4.2, about 4.3, about 4.4, about 4.5, about 4.6, about 4.7, about 4.8, about 4.9, and about 5. In still further aspects, c can have a value that falls within any range formed by the mentioned above values, for example, it can be in a range of about 2.01-about 5, about 2.1-about 5, about 2.5-about 5, about 3-about 5, about 3.5-about 5, about 4-about 5, about 4.5-about 5, and so on.

In still further aspects, Y is a halogen, and wherein 0≤d≤1, including exemplary values of 0, about 0.01, about 0.1, about 0.2, about 0.3, about 0.4, about 0.5, about 0.6, about 0.7, about 0.8, about 0.9, and about 1. It is understood that when d is zero, Y is not present. In yet still further aspects, Y can be present in any amount that falls between any two foregoing values. In still further aspects, Y can be present in an amount that falls in any range formed by any two foregoing values. For example, d can be in a range of about 0.001-about 1, about 0.01-about 1, about 0.05-about 1, about 0.1-about 1, about 0.1-about 0.9, about 0.1-about 0.8, about 0.1-about 0.5, and so on. In still further aspects, when d>0, Y is Cl, Br, I, F, or a combination thereof.

In still further aspects, the M² can further comprise a dopant comprising, but not limited to, one or more of Mg, Ba, Ca, Sr, Al, B, Ga, Si, Ge, As, Zn, Sn, Sb, In, or any combination thereof. It is understood that dopants can be present in any amount, as disclosed above.

In yet still further aspects, the M¹ is Na, while the M² is Co, Fe, Mn, or a combination thereof. In yet still further aspects, X is S or Se or Te, O, or a combination thereof. In yet still further aspects, the active material comprises Na₆CoS₄. In still further aspects, the active material comprises Na₆FeS₄. In still further aspects, the active material comprises Na₆MnS₄.

In still further aspects, the active material can further comprise a conductive agent. It is understood that the conductive agent can comprise any known conductive materials in the art of electrochemical cells. In some aspects, the conductive agent can comprise one or more of carbon black, acetylene black, carbon nanotubes, graphene, graphite, modified and unmodified carbon, conductive polymers, conductive oxides, conductive ceramics, or any combination thereof. It is understood that any conductive polymers can be used, for example, conductive polymers can comprise polyacetylene (PA), polypyrrole (PPy), polythiophene (PTH) polyindole (PI), polyaniline, poly(3,4-ethylenedioxythiophene) (PEDOT), poly(3,4-ethylenedioxythiophene) polystyrene sulfonate (PEDOT:PSS), polyfuran (PF), poly(phenylenevinylene) (PPV), poly(para-phenylene) (PPP), polyacrylonitrile (PAN), or any combinations thereof.

In still further aspects, the active material further comprises a binder. Any known art of battery binders can be used. For example, the binders can comprise poly(vinylidene fluoride) (PVDF), polyethylene oxide, cellulose, carboxymethylcellulose, polytetrafluoroethylene, styrene-butadiene rubber, polyvinylpyrrolidone (PVP), or any combinations hereof.

### Batteries

Disclosed herein are secondary batteries that comprise any of the disclosed above cathode electrodes without limitations. Some exemplary cathode materials and batteries comprising the same are shown in the examples below. In still further exemplary and unlimiting aspects, the battery is a sodium-ion battery. It is understood, however, that similar materials can be formed for lithium-ion, potassium-ion, magnesium-ion, or calcium-ion batteries. In such exemplary aspects, M¹ would comprise Li, K, Mg, or Ca, respectively.

In some exemplary and unlimiting aspects, the cathode materials present in the sodium-ion battery can comprise Na₆CoS₄, Na₆FeS₄, or Na₆MnS₄ or a combination thereof.

In still further aspects, the battery further comprises an anode electrode and an electrolyte.

In certain aspects, the electrolyte is a liquid electrolyte comprising a salt and a solvent. In such exemplary and unlimiting aspects, the salt comprises a cation that is a cation of alkali and/or alkaline-earth metal present in the complex. For example, for sodium-ion batteries, the salt can comprise one or more of sodium fluorophosphate (NaPF6), sodium fluoroborate (NaBF4), sodium tetraphenylborate (NaBPh4), sodium bis(fluorosulfonyl)imide (NaFSI), sodium bis(trifluoromethanesulfonyl)imide (NaTFSI), sodium (fluorosulfonyl)(trifluoromethanesulfonyl)imide (NaFTFSI), sodium perchlorate (NaClO4), sodium nitrate (NaNO3), sodium 4,5-dicyano-2-(trifluoromethyl)imidazole (NaTDI), sodium 4,5-dicyano-2-(pentafluoromethyl)imidazole (NaPDI), and sodium difluorooxalato borate (NaDFOB), or any combination thereof. Yet in the aspects where the battery is a Li-ion battery or potassium-ion battery, any of the mentioned above salts with Li or K cation (instead of Na cation) can be utilized.

In still further aspects, the solvent comprises one or more of ethylene carbonate (EC), 1,2-Dimethoxyethane (DME), propylene carbonate (PC), dimethyl carbonate (DMC), diethyl carbonate (DEC), 1,2-Dimethoxyethane (DME), fluoroethylene carbonate (FEC), tetrahydrofuran (THF), diethylene glycol dimethyl ether (Diglyme), triethylene glycol dimethyl ether (TDEM), tetraethylene glycol dimethyl ether (TEGDME), and vinylene carbonate (VC), Bis(2,2,2-trifluoroethyl) ether (BTFE), 1,1,2,2-tetrafluoroethyl 2,2,3,3-tetrafluoropropylether (TTE), tris(2,2,2-trilfuoroethyl) orthoformate (TFEO), trimethylphosphate (TMP), triethylphosphate (TEP), or any combination hereof. It is understood that the electrolyte can comprise one solvent or a mixture of two or more solvents. If more than one solvent is present, such solvents can be in any weight or volume ratio relative to each other.

In still further aspects, the salt can be present in the electrolyte in any amount that provides the desired conductivity and can be dictated by the solubility of the salt in a specific solvent. In certain aspects, the salt is present in an amount of about 0.01 M to about 3 M, including exemplary values of about 0.05 M, about 0.1 M, about 0.2 M, about 0.3 M, about 0.4 M, about 0.5 M, about 0.6 M, about 0.7 M, about 0.8 M, about 0.9 M, about 1 M, about 1.1 M, about 1.2 M, about 1.3 M, about 1.4 M, about 1.5 M, about 1.6 M, about 1.7 M, about 1.8 M, about 1.9 M, about 2 M, about 2.1 M, about 2.2 M, about 2.3 M, about 2.4 M, about 2.5 M, about 2.6 M, about 2.7 M, about 2.8 M, and about 2.9 M. In still further aspects, the salt can be present in any amount between any two foregoing values. In yet still further aspects, the sale can be present in an amount that falls within a range formed by any two values described above. For example, the salt can be present in an amount of about 0.05 M to about 3 M, about 0.1 M to about 3 M, about 0.5 M to about 3 M, about 1 M to about 3 M, about 1.5 M to about 3 M, about 2 M to about 3 M, and so on. It is understood, however, that in certain aspects, when the solubility of the salt allows it, the salt can be present in an amount higher than about 3 M, higher than about 3.5 M, higher than about 4 M, higher than about 4.5 M, or even higher than about 5 M.

In still further aspects, it is understood that the salt amount can be presented in different units, such as molality or weight (wt) %. In aspects where the salt amount is presented in wt %, the weight percent of the salt is calculated based on the total weight of the electrolyte.

In still further aspects, the battery can comprise any solid or hybrid electrolyte known in the art. In certain aspects, the electrolyte is a solid electrolyte and comprises an inorganic ceramic/glass-ceramic, organic polymer, and ceramic-polymer composite electrolytes. For example, and without limitations, for sodium-ion batteries, the solid electrolyte can comprise doped and undoped NASICON-type compounds, perovskite-type and anti-perovskite-type compounds, nitrides, oxynitrides, beta-alumina, Cryolite-type, argyrodite-type, or polymer-based electrolytes, or ceramic-polymer composite electrolytes, or any combination thereof.

If the electrolyte is polymer-based electrolytes, such electrolytes can further comprise an alkali metal, an alkaline-earth metal salt, or a combination thereof. In still further aspects, any known in the art anode materials can be used. For example, and without limitations, the anode electrode comprises one or more metallic alkali and/or alkaline earth foils, alkali and/or alkaline earth powder, alkali and/or alkaline earth meshes, alkali and/or alkaline earth alloys, carbon materials, non-alkali and/or non-alkaline earth metal alloys, nonmetal alloys, compound materials, or any combination thereof. Yet in still further aspects, the battery can be “anodeless.” In such aspects, the anode electrode is a current collector for an alkali metal or alkaline earth metal deposition during a plating step. In such aspects, the current collectors can be a metal or another conductive material, such as (but not limited to) nickel (Ni), copper (Cu), aluminum (AI), iron (Fe), stainless steel, or conductive carbon materials. The current collector may be a foil, a foam, or a polymer substrate coated with a conductive material.

In still further aspects, where the battery is a sodium-ion battery, the anode electrode comprises any known in the art elemental or compound anode suitable for sodium-ion battery applications.

In still further aspects, where batteries comprise a liquid electrolyte, for example, the batter can further comprise a separator. In such aspects, any known in the art separators that are capable of achieving the desired results can be used. For example, and without limitations, the separators can comprise glass fiber, a porous polymer film (e.g., polyethylene- or polypropylene-based material) with or without a ceramic coating, or a composite (e.g., a porous film of inorganic particles and a binder). One exemplary polymeric separator is a polyethylene (PE) membrane.

Another exemplary polymeric separator is a polypropylene (PP) membrane. Another exemplary polymeric separator is a Celgard® 3501 surfactant-coated polypropylene membrane. The separator may be infused with any of the disclosed herein electrolytes.

In still further aspects, the batteries disclosed herein exhibit a specific capacity of about 100 mAh g⁻¹ to about 600 mAh g⁻¹ at a discharge rate of at least about 0.1 C. For example, the batteries can exhibit a specific capacity of about 100 mAh g⁻¹ to about 600 mAh g⁻¹, including exemplary values of about 120 mAh g⁻¹, about 150 mAh g⁻¹, about 200 mAh g⁻¹, about 250 mAh g⁻¹, about 300 mAh g⁻¹, about 350 mAh g⁻¹, about 400 mAh g⁻¹, about 450 mAh g⁻¹, about 500 mAh g⁻¹, about 550 mAh g⁻¹, and about 590 mAh g⁻¹ at a discharge rate of at least about 0.1 C, of at least about 0.2 C, of at least about 0.5 C, of at least about 1 C, of at least about 2 C, of at least about 3 C, of at least about 4 C, of at least about 5 C, and so on. It is understood that the specific capacity can fall between any disclosed above values or can fall within any range formed by the disclosed above values. In certain aspects, the batteries disclosed herein exhibit a specific capacity of about 100 mAh g⁻¹ to about 600 mAh g⁻¹, about 150 mAh g⁻¹ to about 600 mAh g⁻¹, about 200 mAh g⁻¹ to about 600 mAh g¹, about 300 mAh g⁻¹ to about 600 mAh g⁻¹, about 400 mAh g⁻¹ to about 600 mAh g⁻¹, about 500 mAh g⁻¹ to about 600 mAh g⁻¹, and so on at any of the disclosed above discharge rates.

In still further aspects, the batteries disclosed herein can exhibit a capacity retention of at least about 75% over at least about 200 cycles. Yet in still further aspects, the batteries disclosed herein can exhibit a capacity retention of at least about 75% over at least about 500 cycles. In yet still further aspects, the battery exhibits a capacity retention of at least about 75%, at least about 80%, at least about 85%, at least about 90%, at least about 95%, at least about 99%, over at least about 500 cycles. It is understood that such capacity retention can also be observed for at least about 700 cycles, at least about 1,000 cycles, at least about 5,000 cycles, at least about 10,000 cycles, or at least about 20,000 cycles.

In still further aspects, the batteries disclosed herein can exhibit a Coulombic efficiency greater than about 80%, greater than about 85%, greater than about 90%, greater than about 95%, or greater than about 99% over at least about 500 cycles. It is understood that such a Coulombic efficiency can also be observed for at least about 700 cycles, at least about 1,000 cycles, at least about 5,000 cycles, at least about 10,000 cycles, or at least about 20,000 cycles.

In still further aspects, in the operation of any of the disclosed herein batteries, a cathode redox may or may not involve alkali metal polysulfide formation and/or shuttling.

In still further aspects, the secondary batteries disclosed herein are capable of operating in a temperature range from about −30° C. to about 60° C., including exemplary values of about −25° C., about −20° C., about −15° C., about −10° C., about −5° C., 0° C., about 5° C., about 10° C., about 15° C., about 20° C., about 25° C., about 30° C., about 35° C., about 40° C., about 45° C., about 50° C., and about 55° C. It is further understood that the batteries can operate at any value that falls between any foregoing values on in any range that is formed by any of the disclosed values. For example, the secondary batteries disclosed herein are capable of operating in a temperature range from about −25° C. to about 60° C., about −10° C. to about 60° C., about 0° C. to about 60° C., about 10° C. to about 60° C., about 20° C. to about 60° C., about 30° C. to about 60° C., or about 40° C. to about 60° C., or about −30° C. to about 50° C., −30° C. to about 40° C., about −30° C. to about 30° C., about −30° C. to about 20° C., about −30° C. to about 10° C., about −30° C. to about 0° C., and so on.

By way of example, the secondary batteries of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, according to the present disclosure, the batteries can be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 individual batteries of the present disclosure. Cells in multi-cell batteries may be arranged in parallel or in series.

### Methods

Also disclosed herein are methods of making any of the disclosed above cathode materials. In certain aspects, disclosed herein is a method comprising: (a) forming a mixture comprising an alkali metal or an alkaline-earth metal, one or more transition metals, and a chalcogen-group element; (b) heating the mixture to form an active material represented by M¹M²X, wherein M¹ is an alkali metal ion or an alkali-earth metal ion, wherein M² comprises one or more transition metal ions; and wherein X comprises at least one chalcogen anion, and wherein M¹, M², and X are present in a predetermined ratio.

In still further aspects, M¹ is Li, Na, K, or a combination thereof. Yet in still further aspects, M² is Co, Fe, Mn, Ni, Al, B, V, Ti, Cr, Cu, Ga, Si, Ge, As, Zr, Nb, Ta, Mo, W, Pd, Pt, Re, Cd, or a combination thereof. In still further aspects, M² can comprise a dopant present in any of the disclosed above amounts. In yet still further aspects, M² can comprise one or more of Mg, Ba, Ca, Sr, Al, B, Ga, Si, Ge, As, Zn, Sn, Sb, In, or any combination thereof.

In still further aspects, X is an anion of S, Se, Te, O, or a combination thereof.

In still further aspects, the active material can further comprise Y and is represented by M¹M²XY, wherein Y comprises a halogen, and wherein M¹, M², X, and Y are present in a predetermined ratio.

In some exemplary and unlimited aspects, the active material formed by the disclosed herein methods can be represented by Mₐ¹M_{b}²X_{c}Y_{d}, wherein M¹ is Na, 2≤a≤7, M² is one of Co, Fe, Mn, Ni, V, Ti, Cr, Cu, Zr, Nb, Ta, Mo, W, Pd, Pt, Re, Cd, or a combination thereof, 0<b≤2; X is one or more of S, Se, Te, O, or a combination thereof 2<c≤5, Y is a halogen, and wherein 0≤d≤1, where the exemplary values of x, b, c, and d are disclosed above.

In still further aspects, the mixture is formed from the elemental materials. For example, and without limitations, the mixture can comprise elemental Na, elemental transition metal and elemental chalcogen, for example, sulfur. In such aspects, the active material can be formed by the direct heating of such a mixture.

In certain aspects, the mixture can be formed from at least one of the alkali metals, the alkaline-earth metal, one or more transition metals, and the chalcogen-group element in the mixture is present as an ion. For example, in some aspects, at least one of the alkali metals, the alkaline-earth metal, one or more transition metals, and the chalcogen-group element in the mixture are present as an ion. In such exemplary aspects, the mixture can comprise a salt of the alkali or alkaline-earth metal and a salt of the transition metal. In certain aspects, one of the salts can comprise at least one chalcogen element. Yet, in other aspects, the mixture can comprise chalcogen anion. In yet other aspects, the mixture can comprise at least one of the alkali metal ions, the alkaline-earth metal ions, and the chalcogen element in elemental form. In certain aspects, the active material can be formed by the direct heating of such a mixture.

In certain aspects, when the mixture comprises some of the disclosed constituents in ionic form, such a mixture can be formed in a first solvent. In aspects where the mixture is formed in the first solvent, the first solvent is an aqueous solution, an organic solvent, or a combination thereof. In certain aspects, the first solvent is water. In yet other aspects, the first solvent is an organic solvent such as alcohol, N-methyl pyrrolidone, water, alcohols, acetone, toluene, acetonitrile, or a combination thereof. In still further aspects, the first solvent is a mixture of water and any of the disclosed herein organic solvents.

In still further aspects, the mixture comprises some of the disclosed constituents in ionic form, such a mixture can comprise a reducing or an oxidizing agent. In certain aspects, the reductive agent is present, and it can comprise carbon, aluminum, or any combination thereof.

In still further aspects, the mixture can comprise any of the disclosed above conductive agents, binders, or a combination thereof.

In still further aspects, the step of heating the powder is performed at a temperature of about 500° C. to about 1000° C., including exemplary values of about 550° C., about 600° C., about 650° C., and about 700° C., about 750° C., about 800° C., about 850° C., about 900° C., and about 950° C. in one or more heating steps. In still further aspects, the temperature can have a value that falls between any of the forgoing values or can fall within a range formed by any of the disclosed above values.

In still further aspects, the method of forming the cathode electrode can further comprise forming a slurry of the active material and a binder in a second solvent. In such aspects, the binder can be any of the disclosed above binders. In still further aspects, the second solvent comprises one or more organic solvents. Any known in the art organic solvents that are suitable for battery applications can be utilized.

In still further aspects, the slurry is disposed on a substrate, and the second solvent is substantially removed. In such aspects, the substrate and cathode materials are heated to dry the cathode material and remove the slurry. In still further aspects, the substrate can be any conductive material known in the art. In certain aspects, the substrate can be a powder, a film, a connector, a mesh, a foam, or any combination thereof.

Also, disclosed herein is a method comprising: providing any of the disclosed herein cathode electrodes; providing any of the disclosed herein anode electrodes; providing any of the disclosed herein electrolytes; and providing any of the disclosed herein separators; forming any of the disclosed herein secondary batteries.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Methods

Preparation of Na₆CoS₄@C, Na₆FeS₄@C, Na₆MnS₄@C, and Na₆ZnS₄@C

A one-pot chemical method for the preparation of carbon-coated Na₆CoS₄ (Na₆CoS₄@C) was developed. First, a mixture of Na₂SO₄, CoSO₄·7H₂O, Ketjen Black carbon, and polyvinylpyrrolidone (average MW~1,300,000) in certain amounts were added into an ethanol-water solution (1:1=v:v). The obtained mixture was then intensively ultrasonicated for 30 min to form a uniform suspension.

Then, the mixture was transferred to a rotary evaporator to dry the mixture and recycle the ethanol at 60° C. for several hours. The dried sample was further dry ball-milled with a planetary ball mill. The milling duration was 15 iterations of 30 minutes of milling, followed by 30 minutes of rest. Then, the fine powder obtained was heated at 800° C. for 2 h with a heating and cooling rate of 5° C. min⁻¹ to obtain Na₆CoS₄@C. The content of Na₆CoS₄@C was determined to be ~90 wt. % by comparing the weight of Na₆CoS₄@C before and after stirring in HCl for one day since Na₆CoS₄ is soluble in HCl. The Na₆FeS₄@C, Na₆MnS₄, and Na₆ZnS₄ were prepared following the same process as for Na₆CoS₄@C except with the use of FeSO₄·7H₂O, MnSO₄·4H₂O or ZnSO₄·7H₂O instead of CoSO₄·7H₂O.

Preparation of the Na₆CoS₄@C cathode. Wet milling was conducted in a PTFE bottle with a mixture of 80 wt. % composite cathode, 5 wt. % CNT, 5 wt. % super-P, and 10 wt. % PVP/PEO binder in DME/acetonitrile with a zirconia grinding medium for 24 h with a long roll jar-milling system. After coating the above slurry onto an aluminum foil, the electrode was dried inside a glove box at 60° C. for 24 h to remove the solvent. The cathodes with a Na₆CoS₄ content of 72 wt. % were obtained.

Characterizations. The crystalline structures of the obtained samples were characterized by powder X-ray diffraction (PXRD) (Rigaku a MiniFlex 600 X-ray diffractometer) with Cu Kα (λ=1.54184 Å) radiation. The morphology investigation was performed with a scanning electron microscope (FEI Quanta 650 SEM) operated at 20 kV. XPS analysis was performed with a Kratos Analytical spectrometer at room temperature with monochromatic Al Kα (1,486.6 eV) radiation. TEM and STEM analyses were performed with a JEOL 201 OF field emission TEM at 200 kV.

Synchrotron X-ray diffraction (XRD). Synchrotron-based operando energy dispersive X-ray diffraction (ED-XRD) measurements were conducted with beamline 6BM-A at the Advanced Photon Sources in Argonne National Laboratory. The white X-ray radiation was generated by bending magnets with an energy range of 20-200 keV. The detection angles were 2.477° for the Canberra germanium detector to collect the diffraction pattern. The operando experiment was conducted with a transmission geometry and provided spatial and temporal mapping capabilities. Coin cells were cycled at C/10 within 1.2 to 2.8 V, during which the ED-XRD patterns were collected for 60 s at one point. The height (10 μm) and width (2 mm) of the incident X-ray beam were kept constant during the measurement. Two points at different amplitudes, corresponding to different locations to the separator, were measured continuously until the cells went through one full cycle. The measured intensities of the two data points were added to improve the signal-to-noise ratio. Rietveld refinement was not applied to calculate the crystalline lattice parameters because of the limited detectable Q range and different X-ray energies during measurement. Instead, the peak positions of the (101) peak and (003) peak were identified and used to calculate the evolution of the crystalline lattice parameters. It is worth noting that the accuracy of the fitted lattice parameters was affected by the broadening of these two peaks and the signal-to-noise ratio.

Electrochemical measurements. Coin-type (CR2032) cells were assembled inside an Ar-filled glove box with sodium metal as the anode and Celgard 2500 separator. The monolayer dimension of the pouch cell in our work was 4.78 cm×8.15 cm, and the cycling pressure was 35 psi. An Arbin battery cycler was used to conduct the cycling test between 1.2 and 2.8 V with a current rate of C/10, assuming a 495 mA h g⁻¹ capacity, at room temperature.

Theoretical Calculations. All calculations were carried out with the standard DFT using the Vienna ab initio Simulation Package (5.4.4 VASP) within the generalized gradient approximation (GGA) as formulated by the Perdew-Burke-Ernzerhof (PBE) functional. An energy cutoff of 500 eV was adopted, and the Brillouin zone was sampled with 3×3×4 k-points using the Monkhorst-Pack scheme grid for geometry optimization and self-consistent calculations. Supercells of Na₁₂Zn₂S₈, Na₁₂Mn₂S₈, Na₁₂Co₂S₈, and Na₁₂Fe₂S₈ were selected to compare the differences in electronic structural properties. The atomic position was fully relaxed until the maximum force on each atom and total energy change was less than 0.02 eV/A and 10-5 eV.

### Example 1

In this example, a new class of ternary transition-metal sulfides (Na₆MS₄), including Na₆MnS₄, Na₆FeS₄, Na₆CoS₄, and Na₆ZnS₄, as cathodes for SIBs with high capacities is presented. These materials are known to display interesting magnetic and optical properties (10-13), but their electrochemical properties are not known. Here, a facile way to synthesize Na₆MS₄ (M=Mn, Fe, Co, and Zn) via a carbothermal reaction is presented. Unlike the conventional layered oxide cathodes used in LIBs and SIBs that rely exclusively on the redox of transition metals (cationic), the reversible reaction of Na₆MS₄ involves an anionic redox process. They exhibit remarkably high reversible capacities of close to 400 mAh g⁻¹ with a long cycle life, following an initial six-electron conversion reaction involving a transformation from highly crystalline to an amorphous structure, which shows great potential compared to most published cathodes for SIBs as demonstrated in FIG. 1B.

### The Need for Anion-Redox-Based Materials

For SIBs, there are 3 major classes of inorganic cathode materials. A schematic showing their operation mechanisms is given in FIG. 1A. The specific capacities, energy densities, and cycle life of some common SIB cathode materials are shown in FIG. 1B and are detailed in Tables 1 and 2.

TABLE 1
A comparative analysis of the cycling performances of Na₆CoS₄@C shown in
this work, and the literature reports on other cathodes for sodium-ion batteries

| | | Specific | | | |
|---|---|---|---|---|---|
| | | capacity | | | |
| | Rate | (mAh | Cycle | Cell | |
| Material | (C) | g⁻¹) | number | type | Reference |
| Na₆CoS₄@C | 0.1 | 392 | 500 | coin | This |
| | 0.1 | 408 | 40 | Anode | work |
| | | | | -free | |
| | 0.1 | 341 | 200 | pouch | |
| Na_{1.72}MnFe(CN)₆ | 1 | 120 | 30 | Coin | R1 |
| K_{0.4}[Ni_{0.2}Mn_{0.8}]O₂ | 1 | 166.84 | 500 | Coin | R2 |
| Na₃Mn(TiO₄)₃ | 1 | 56.74 | 100 | Coin | R3 |
| Na₃Ni₂RuO₆ | 1 | 77 | 1000 | Coin | R4 |
| Na₄MnCr(PO₄)₃ | 0.2 | 122.86 | 50 | Coin | R5 |
| Na₃V_{1.9}(Ca, Mg, Al, Cr, Mn)_{0.1}(PO₄)₂ | 1 | 102.5 | 300 | Coin | R6 |
| F₃ | | | | | |
| Na_{0.67}Ni_{0.33}Mn_{0.67}O₂ | 0.1 | 96.55 | 50 | Coin | R7 |
| Ca_{0.07}Na_{0.26}MnO₂ | 50 | 24.4 | 1000 | Coin | R8 |
| P2-type | 5 | 53.325 | 1000 | Coin | R9 |
| Na_{2/3}Ni_{1/6}Mn_{2/3}Cu_{1/9}Mg_{1/18}O₂ | | | | | |
| Na_{2/3}Li_{1/6}Fe_{1/6}Co_{1/6}Ni_{1/6}Mn_{1/3}O₂ | 5 | 71.34 | 300 | Coin | R10 |
| Na_{3.75}V_{1.25}Mn_{0.75}(PO₄) | 5 | 84.48 | 100 | Coin | R11 |
| NASICON Na₃Cr_{0.5}V_{1.5}(PO₄)₃ | 0.2 | 141.5 | 100 | Coin | R12 |
| | 5 | 97.7 | 500 | Coin | |
| Na_{0.07}NFMO₂ | 1 | 178.2 | 500 | Coin | R13 |
| Na_{3.14}V_{1.93}Na_{0.07}(PO₄)₂F₃ | 10 | 75.13 | 1000 | Coin | R14 |
| O3-type | 0.2 | 115 | 100 | Coin | R15 |
| Na(Ni_{0.3}Fe_{0.4}Mn_{0.3})O₂ | | | | | |
| Na_{0.44}MnO₂ | 0.5 | 84.2 | 1000 | Coin | R16 |
| O′3-Na₃Ni₂BiO₆ | 0.05 | 96.46 | 50 | Coin | R17 |
| P2-Na_{0.67}Ni_{0.33}Mn_{0.67}O₂ | 0.01 | 89.6 | 10 | Coin | R18 |
| P2-Na_{0.67}Ni_{0.33}Ti_{0.67}O₂ | 0.05 | 69.75 | 30 | Coin | R19 |
| P2-Na_{0.6}Cr_{0.6} Ti_{0.4}O₂ | 0.1 | 69.56 | 200 | Coin | R20 |
| P2-Na_{0.67}Ni_{0.17}Co_{0.17}Ti_{0.67}O₂ | 0.2 | 51.865 | 500 | Coin | R21 |
| P2-Na0.6Mn0.8Li0.2O2 | 0.067 | 190 | 100 | Coin | R22 |
| NVP@rGO | 5 | 92 | 300 | Coin | R23 |
| Na_{0.44}Mn_{0.89}Ti_{0.11}O₂ | 5 | 71 | 1000 | Coin | R24 |
| C-coated | 2 | 66 | 1000 | Coin | R25 |
| Na_{3.64}Fe_{2.18}(P₂O₇)₂ | | | | | |
| P2-Na_{0.67}MnO₂ | 10 | 102 | 500 | Coin | R26 |
| P3- Na_{2/3}Ni_{1/4}Mg_{1/12}Mn_{2/3}O₂ | 0.1 | 108.75 | 50 | Coin | R27 |
| | 1 | 97.5 | 100 | Coin | |
| Spinel-layered Mn-based oxide | 0.1 | 142.9 | 150 | Coin | R28 |
| cathode | | | | | |
| Na₃V₂(PO₄)₃ anchored on | 100 | 54 | 20000 | Coin | R29 |
| freestanding graphite foam | | | | | |
| (NVP@C-GF) | | | | | |
| Na₃V₂O₂(PO₄)₂F/graphene | 1 | 126.49 | 500 | Coin | R30 |
| aerogels | 5 | 97.9 | 500 | Coin | |
| Na_{2/3}(Fe_{1/2}Mn_{1/2})O₂ nanofibers | 0.1 | 166 | 80 | Coin | R31 |
| Spongy 3D | 5 | 59 | 1000 | Coin | R32 |
| Na_{3.32}Fe_{2.34}(P₂O₇)₂@C | 0.5 | 105.6 | 300 | Coin | |
| NMZVP@cPAN | 5 | 82 | 1000 | Coin | R33 |
| NaNi_{0.4}Mn_{0.25}Ti_{0.3}Co_{0.05}O₂ | 0.5 | 98 | 180 | Coin | R34 |
| Na₂FePO₄F/C | 4 | 50.82 | 1000 | Coin | R35 |
| O3/O′3-P2 | 0.1 | 97 | 200 | Coin | R36 |
| O3-Na_{0.95}Ni_{0.40}Fe_{0.15}Mn_{0.3}Ti_{0.15}O₂ | 5 | 104.7 | 200 | Coin | R37 |
| P2-Na_{0.75}Ni_{1/3}Ru_{1/6}Mn_{1/2}O₂ | 10 | 81 | 500 | Coin | R38 |
| Na_{0.07}Li_{0.06}Mg_{0.06}Ni_{0.22}Mn_{0.67}O₂ | 0.1 | 85 | 50 | Coin | R39 |
| NVP/C | 1 | 114 | 100 | Coin | R40 |
| O₃-Na_{0.9}Cu_{0.22}Fe_{0.3}Mn_{0.48}O₂ | 0.1 | 97 | 100 | Coin | R41 |
| NaNi_{0.6}Co_{0.05}Mn_{0.35}O₂ | 0.1 | 131.88 | 100 | Coin | R42 |
| maricite NaFePO₄ | 0.05 | 134.9 | 200 | Coin | R43 |
| Na₃V(PO₃)₃N/NGO | 0.1 | 78.9 | 100 | Coin | R44 |
| Na₃V₂(PO₄)₂F₃ | 0.091 | 108.9 | 50 | Coin | R45 |
| Na₄Fe₃(PO₄)₂P₂O₇ | 0.1 | 110.9 | 100 | Coin | R46 |
| Na_{3.1}V₂(PO₄)_{2.9}(SiO₄)_{0.1} | 0.2 | 107.2 | 500 | Coin | R47 |
| Na₂Mn_{0.15}Co_{0.15}Ni_{0.1}Fe_{0.6}Fe(CN)₆ | 0.1 | 94.9 | 500 | Coin | R48 |
| Na_{1.58}Fe[Fe(CN)₆]_{0.92} nanosphere | 0.1 | 127.8 | 800 | Coin | R49 |
| Na_{1.92}Fe₂(CN)₆ | 0.067 | 125.6 | 1000 | Coin | R50 |
| Na₂RuO₃ | 0.2 | 160.2 | 50 | Coin | R51 |
| Prussian Blue | 1 | 78 | 1000 | Coin | R52 |

The first class of SIB cathode materials are intercalation compounds—these have a host crystal structure with channels for Na⁺ ions to be inserted and extracted (FIG. 1A, left). Examples include transition-metal oxides, sulfides, polyanionic materials, and Prussian blue or white materials, wherein the active redox center is the transition-metal ion. As the host structure tends to be stable, they are rechargeable for a few hundred to a few thousand cycles. Unfortunately, the multi-atomic nature of the host structure and a redox reaction with one or less than one electron transfer per transition-metal ion translates to a low theoretical capacity—typically <200 mAh g⁻¹ and despite a high operating voltage (>3 V vs. Na/Na⁺) to a low theoretical energy density of <600 Wh kg⁻¹ (FIG. 1B).

The other class of inorganic cathode materials are elemental cathodes, such as sulfur and oxygen. They typically undergo conversion directly from their elemental form to their reduced form through multi-electron reactions on a lightweight substrate, such as carbon (FIG. 1A, center), and thus possess a very high capacity >1,000 mAh g⁻¹, and despite a lower voltage (between 1.5 to 3 V), they have a theoretical energy density of >1,500 Wh kg⁻¹. However, these conversion reactions are sluggish and inefficient and often involve parasitic reactions. Consequently, the cycle life is poor, typically ranging from a few tens to a couple of hundred cycles (FIG. 1B).

TABLE 2
A comparative analysis of the theoretical capacities
of the cathodes in this work and the other cathodes
in the literature for sodium-ion batteries.

| | Theoret- | | | |
|---|---|---|---|---|
| | ical | | | |
| | capacity | Average | Energy | |
| | (mAh | Voltage | Density | Refer- |
| Material | g⁻¹) | (V) | (Wh/kg) | ence |
| Na₆CoS₄ | 495 | 1.87 | 925.6 | This |
| | | | | work |
| Na₃Ni₂RuO₆ | 130 | 2.92 | 379.6 | R1 |
| Na₃V₂(PO₄)₃ | 110 | 3.4 | 370 | R2 |
| Na₄MnCr(PO₄)₃ | 160.5 | 3.53 | 556.5 | R2 |
| Na₃V_{1.9}(Ca, Mg, Al, Cr, | 128.3 | 3.47 | 445.5 | R3 |
| Mn)_{0.1}(PO₄)₂F₃ | | | | |
| Na_{2/3}Li_{1/6}Fe_{1/6}Co_{1/6}Ni_{1/6}- | 186.8 | 4.5 | 840.6 | R4 |
| Mn_{1/3}O₂ | | | | |
| NASICON Na₃Cr_{0.5}V_{1.5}(PO₄)₃ | 140 | 3.8 | 532 | R5 |
| Na_{0.44}MnO₂ | 121 | 3 | 363 | R6 |
| NVP | 117 | 3.4 | 397.8 | R7 |
| Na_{3.64}Fe_{2.18}(P₂O₇)₂ | 106 | 4 | 424 | R8 |
| Na_{3.32}Fe_{2.34}(P₂O₇)₂ | 117.4 | 3 | 352.2 | R9 |
| Na₂FePO₄F | 124 | 4.5 | 558 | R10 |
| P2/P3- | 119 | 3.36 | 400 | R11 |
| Na_{0.7}Li_{0.06}Mg_{0.06}Ni_{0.22}Mn_{0.67}O₂ | | | | |
| NFM | 160 | 3.5 | 560 | R12 |
| Na_{0.78}Cu_{0.27}Zn_{0.06}Mn_{0.67}O₂ | 120 | 3.4 | 408 | R13 |
| Prussian white (PW) | 169 | 3.6 | 608 | R14 |
| Prussian Blue (PB) | 170 | 3.6 | 612 | R15 |

At the intersection of these two material classes are hybrid or anion-redox-based cathodes. These are transition-metal oxides or sulfides, but with the anions acting as the active redox species. These materials possess a host crystal structure that could undergo rearrangements to facilitate the conversion of the anions within a matrix (FIG. 1A, right). Therefore, the reactions are not sluggish and are efficient. Consequently, a life of a few hundred cycles can be obtained. As the anions undergo multi-electron reactions, capacities between 300 and 500 mAh g⁻¹ can be obtained.

### Synthesis of Cathode Materials

A facile, scalable synthesis of Na₆MS₄ is critical for its practical application in SIBs. Here, according to reaction 1, a facile carbothermal reduction of metal sulfates with carbon to obtain Na₆MS₄ was developed, as shown in Reaction (1).

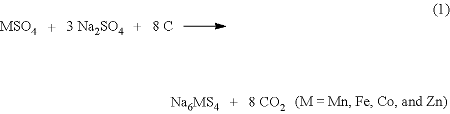

In Reaction (1), excess carbon was employed to ensure a complete reduction of the sulfates and ensure efficient conversion. Any unreacted, remaining carbon will also serve to construct a conductive network within the cathode. The procedure is detailed below by taking Na₆CoS₄ as an example. It is understood, however, that cathode materials with different than Na alkali metals (for example, Li or K metals) can also be prepared. Initially, all the reactants (Ketjen Black, Na₂SO₄, and CoS₀₄) were ultrasonically mixed in water and ethanol and transferred to a rotary evaporator to dry the mixture. Followed by a high-temperature treatment of the mixture at 800° C. under nitrogen, Na₆CoS₄ was obtained. A similar procedure was adopted with M=Co, Fe, Mn, Zn in Na₆MS₄. Such a one-pot synthesis ensures a molecular-level mixing of the reactants, leading to the formation of nanosized Na₆MS₄ particles in the carbon matrix (Na₆MS₄@C).

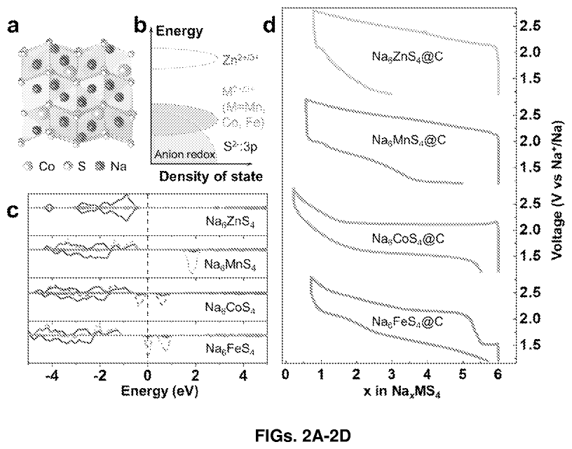

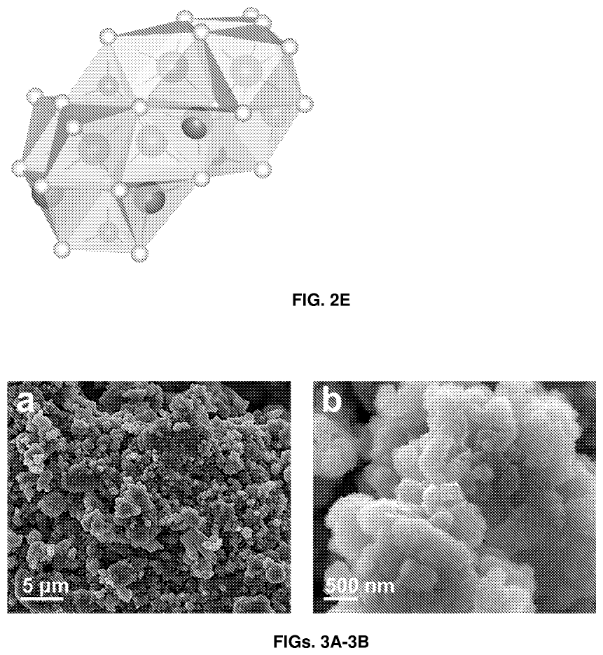

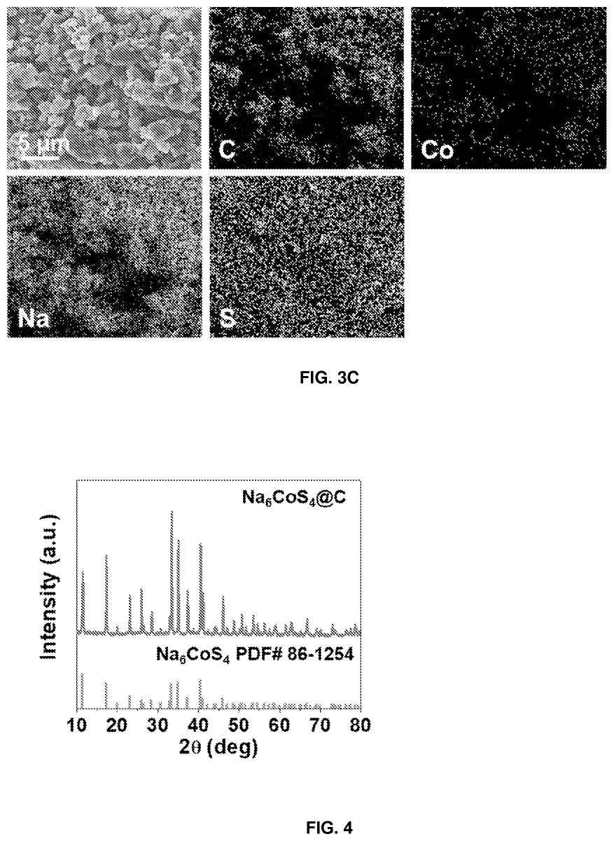

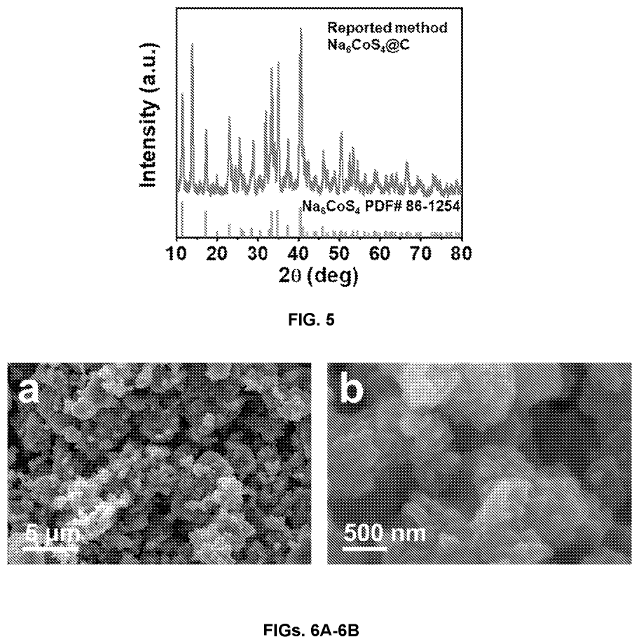

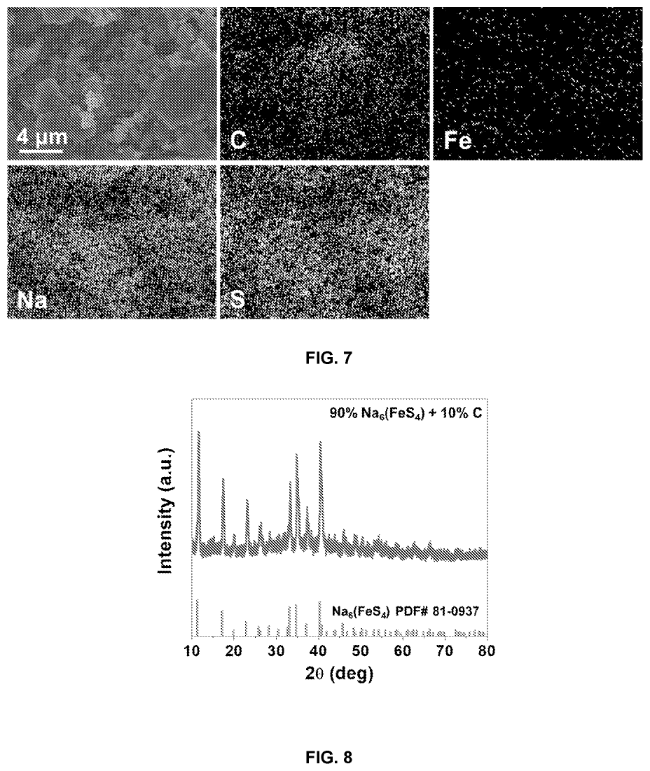

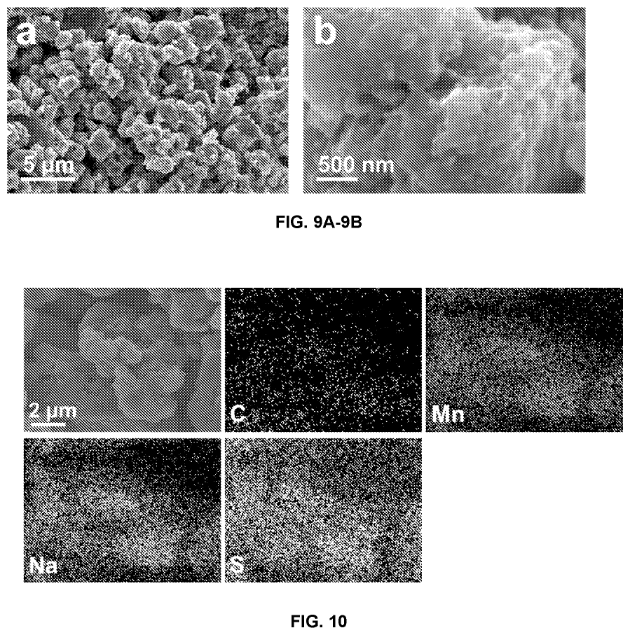

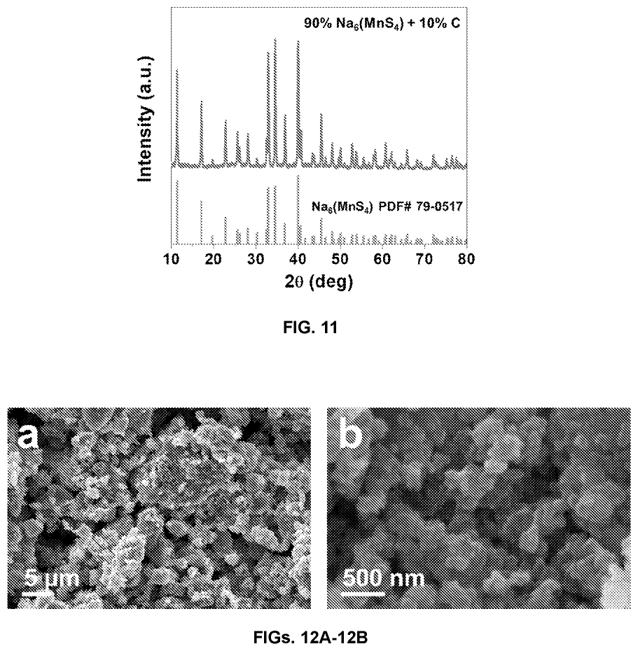

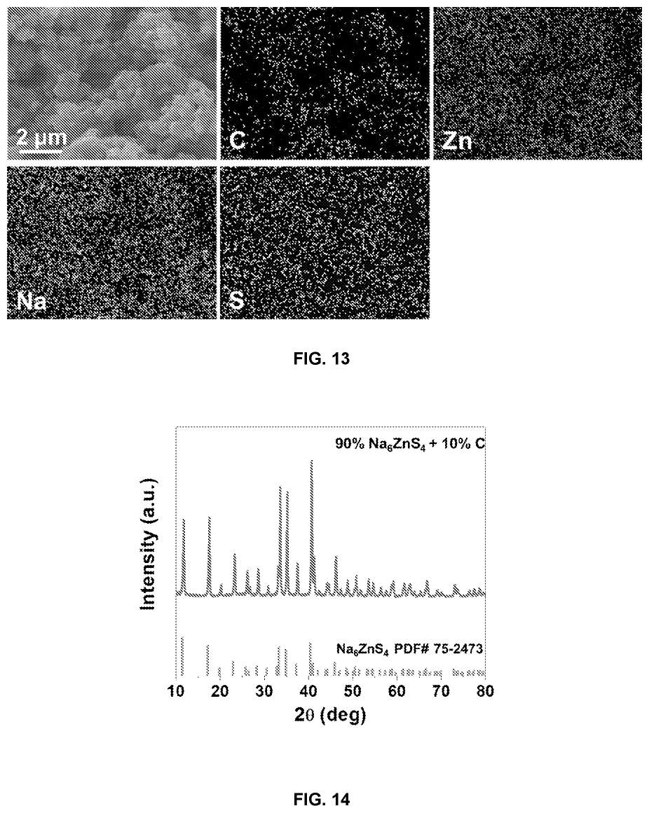

As shown in FIG. 2A, Na₆MS₄ crystallizes in the hexagonal P6₃mc space group. The structure is comprised of a hexagonal closed-packed sulfur lattice in which the M²⁺ ions occupy the tetrahedral sites, forming MS₄ tetrahedra, while the Na⁺ ions occupy both the tetrahedral and octahedral sites equally, creating two inequivalent Na⁺ sites in a 1:1 ratio. In the resulting structure, the NaS₄ tetrahedra share faces, while the NaS₆ octahedra share edges with the MS₄ tetrahedra (11). The structure of Na₆MS₄@C was investigated with scanning electron microscopy (SEM) and transmission electron microscopy (TEM). As shown in FIGS. 3B and 3C, the Na₆CoS₄@C composite comprises nanoparticles clustered in secondary particles of approximately 1 μm that are interconnected to form a three-dimensional porous network. The distribution of Na₆CoS₄@C is further revealed by the elemental mapping images in FIGS. 3A-3F, suggesting that Na₆CoS₄ is uniformly distributed along with carbon. The XRD pattern in FIG. 4 confirms the high crystallinity of Na₆CoS₄ (PDF #86-1254). In addition, the Na₆CoS₄ was also prepared according to the previously reported method (12). As shown in FIG. 5, the prepared sample shows impurity phases, such as Na₅Co₂S₅ and Na₂S. These results further confirm that the method disclosed herein ensures a molecular-level mixing of the reactants, leading to a uniform reaction. All the other samples, including Na₆FeS₄@C, Na₆MnS₄@C, and Na₆ZnS₄@C, also show structures similar to Na₆CoS₄@C, as seen in FIGS. 6-14.

As shown in FIG. 2A, amongst the transition metal ions, Co²⁺ and Fe²⁺ should be good choice for sulfides since the Co^{2+/3+}: 3d and Fe^{2+/3+}: 3d redox couples are expected to be pinned at the top of the S²⁻: 3p band. The spin-projected density of states (pDOS) for Na₆ZnS₄, Na₆MnS₄, Na₆CoS₄, and Na₆FeS₄ were calculated, and the results are plotted in FIG. 2B. The results reveal that Na₆ZnS₄ and Na₆MnS₄ have a wider bandgap compared to Na₆CoS₄ and Na₆FeS₄ due to the differences in the location of the M: 3d-band with respect to the top of the S:3p band, suggesting that both Na₆CoS₄ and Na₆FeS₄ would have better electronic conductivity Electrochemical performances

The electrochemical performances of the Na₆MS₄@C samples were evaluated in Na half cells, and the voltage profiles are summarized in FIG. 2C. Na₆ZnS₄@C shows inferior electrochemical activity, as only two Na⁺ ions could be reversibly extracted. The redox activity in Na₆ZnS₄@C is clearly due to the anion redox of S²⁻ as Zn²⁺ with a 3d¹⁰ configuration would not be expected to participate or form Zn³⁺. Also, the limited redox activity in Na₆ZnS₄@C is due to the lying of Zn^{2+/+} energy well above the top of the S²⁻: 2p band and lack of covalent mixing between Zn: 3d and S: 2p orbitals (FIGS. 2B-2C). This contrasts with Na₆CoS₄@C and Na₆FeS₄@C (FIG. 2C), which have much larger electrochemical activity due to the high covalence of the M-S bond, resulting from a significant overlap of the M^{2+/3+}: 3d band with the top of the S²⁻: 2p band (FIG. 2A).

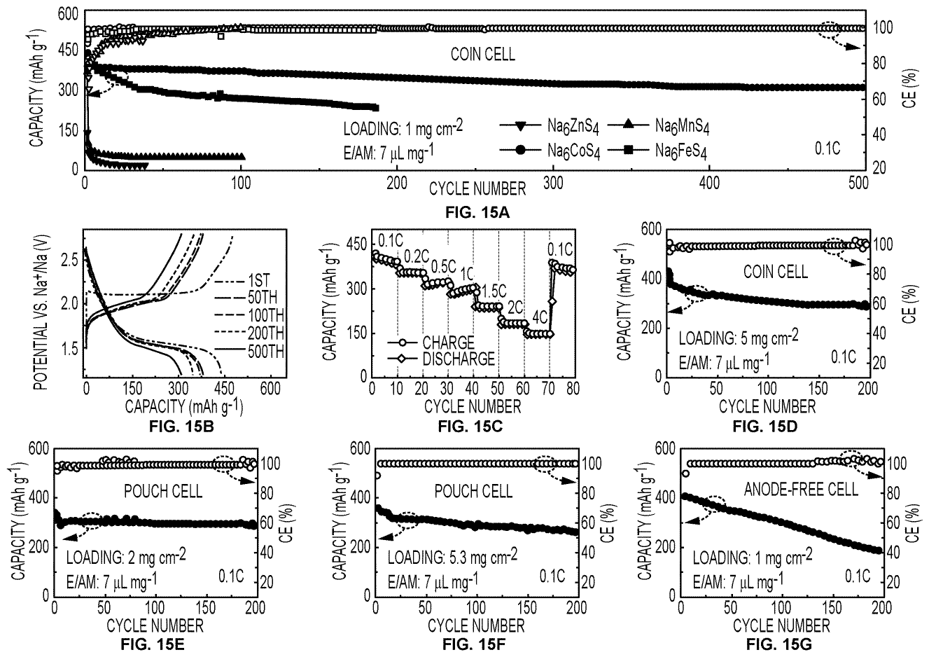

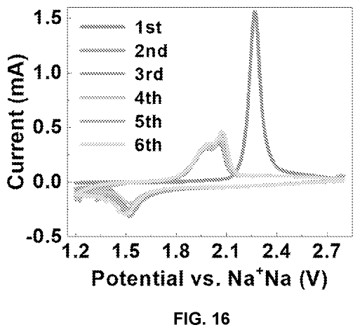

The cycling performances of Na₆ZnS₄@C, Na₆MnS₄@C, Na₆CoS₄@C, and Na₆FeS₄@C are shown in FIG. 15A. It was found that under certain conditions, Na₆ZnS₄@C and Na₆MnS₄@C cathodes show large irreversible capacities that can fade below 50 mAh g⁻¹ after 5 cycles due to the lack of covalence. In contrast, Na₆CoS₄@C and Na₆FeS₄@C show good reversible cycling performance. In this example, Na₆CoS₄@C was selected as a model system to further demonstrate the potential of ternary transition-metal sulfides. The Na₆CoS₄@C cathode delivers a high initial charge-specific capacity of 477 mAh g⁻¹ at 0.1 C rate, which corresponds to ~5.8 Na⁺ ions extracted from Na₆CoS₄@C. Then, 5.3 Na⁺ ions could be inserted reversibly, which corresponds to a discharge capacity of 437 mAh g⁻¹. The discharge capacity becomes stable at 392 mAh g⁻¹ in the subsequent cycles. The fast decay in the first two cycles is mainly due to the transformation of highly crystalline Na₆CoS₄ to an amorphous structure and cathode-electrolyte interphase (CEI) formation, which will be further discussed later. Even after 500 cycles, Na₆CoS₄@C maintains a capacity of 306 mAh g⁻¹, corresponding to a capacity fade rate of 0.04% per cycle. Also, Na₆CoS₄@C exhibits an average Coulombic efficiency of 99.6% over 500 cycles at a 0.1 C rate, indicating high reversibility of the conversion and good structural integrity during repeated cycling. FIG. 16 shows the cyclic voltammetry (CV) curves of the Na₆CoS₄@C cathode for the first six cycles in the voltage range of 1.2 to 2.8 V with a scanning rate of 0.1 mV s⁻¹. A strong anodic peak at 2.27 V was detected in the initial scanning, which can be attributed to the transformation of the crystalline Na₆CoS₄ to an amorphous structure and finally to S/CoS. The cathodic peak at 1.52 V is associated with the conversion of S/CoS back to Na₆CoS₄. After the first sweep, the overlapping CV curves indicate a good reversibility of the conversion.

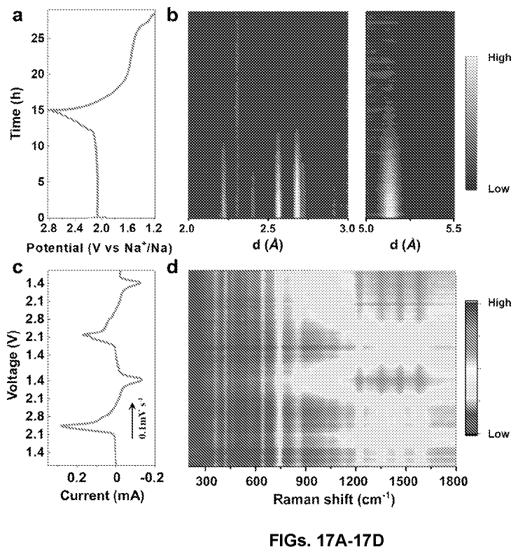

FIG. 15B shows the charge/discharge profiles of the Na₆CoS₄@C cathode at 0.1 C rate. The voltage plateaus match well with the CV results in FIG. 16. Only a slight change in the potential plateau, even after 500 cycles, confirms the high-capacity reversibility of the Na₆CoS₄@C cathode. As shown in FIG. 17C, the rate capability of Na₆CoS₄@C was conducted at various C rates. Na₆CoS₄@C exhibits excellent rate capability with high reversible specific capacities of 418, 354, 312, 283, 240, 197, and 156 mAh g⁻¹ at, respectively, 0.1 C, 0.2 C, 0.5 C, 1 C, 1.5 C 2 C, and 4 C rates. Notably, the capacity recovers to 386 mAh g⁻¹ as the C rate is reduced from 4 C to 0.1 C, indicating the stability of the Na₆CoS₄@C cathode at high rates.

The Na₆CoS₄@C cathode was further evaluated under a high active material (AM) loading of 5 mg cm⁻² and a low electrolyte/AM ratio of 7 μL mg⁻¹ to demonstrate the practical viability of Na₆CoS₄. As shown in FIG. 15D, the cell with a high Na₆CoS₄ loading and a low electrolyte amount practically maintains a cycling performance similar to the cell with a low Na₆CoS₄ loading, demonstrating the outstanding redox kinetics of the Na₆CoS₄.

As shown in FIG. 15E, the pouch cell with a Na₆CoS₄@C loading of 2 mg cm⁻² and a low electrolyte/AM ratio of 7 μL mg⁻¹ delivers an initial specific capacity of 341 mAh g⁻¹. Even after 200 cycles, the pouch cell maintains a high specific capacity of 293 mAh g⁻¹, the most extended cycling lifespan of sodium-ion pouch cells, as summarized in Table 1. It should be noted that after the initial 10 cycles, the pouch cell shows almost no capacity decay upon cycling. To further pursue the practical viability of Na₆CoS₄@C cathode in pouch cell, the loading was further improved to 5.3 mg cm⁻², and the electrolyte amount was further reduced to 4 μL mg⁻¹. As shown in FIG. 15F, the pouch cell with a high loading can deliver a high initial capacity of 357 mAh g⁻¹ and remain stable over 60 cycles. The results further illustrate the stability of the Na₆CoS₄@C cathode.

To further demonstrate the advantage of using the sodium-containing Na₆CoS₄@C cathode, an anode-free cell was constructed with a localized high-concentration electrolyte (LHCE) and Ni foil as the anode current collector for Na deposition. As shown in FIG. 15G, the Ni∥Na₆CoS₄@C cell can still deliver an initial discharge capacity of 408 mAh g⁻¹, which is very close to that of the Na∥Na₆CoS₄@C cell paired with a Na-foil anode, suggesting an efficient deposition of Na in an anode-free Ni∥Na₆CoS₄@C cell. The Ni∥Na₆CoS₄@C anode-free cell maintains 187 mAh g⁻¹ over 40 cycles, demonstrating a highly reversible reaction of Na₆CoS₄ with a high utilization of Na in the anode-free Ni∥Na₆CoS₄@C cell.

Anionic Redox Mechanisms of Na₆CoS₄

The voltage profiles in FIG. 2D indicate a significant potential difference between the first de-sodiation step (charge) and the first sodiation step (discharge) of the Na₆MS₄ class of materials. No change in the shape of the charge/discharge curve is observed in the subsequent cycles (FIG. 15B). This suggests crystalline rearrangements in Na₆MS₄ during the first cycle. This phenomenon was further investigated using a suite of in-situ and in-operando techniques, such as synchrotron-based operando energy dispersive X-ray diffraction (ED-XRD) and Raman spectroscopy with Na₆CoS₄@C cathode as the prototypical compound as it appears to be the most electrochemically reversible sample. ED-XRD was used as the ultrahigh-energy of the X-ray (up to 200 keV) at the sector 6BM-A of the Advanced Photo Source in Argonne National Laboratory, providing a deep penetration depth, allowing for identifying the structural changes in the cathode using normal coin cells (CR2032) for the measurement (14). As shown in FIG. 17A, the cell was tested at 0.1 C rate (1 C=495 mA g⁻¹) between 1.2 and 2.8 V (vs. Na⁺/Na) for one full discharge-charge cycle. In the meantime, the XRD signal was recorded, as demonstrated in the contour plot (FIG. 17B) next to the charge-discharge profile. In-situ Raman spectroscopy was performed to gain an understanding of the transformations after the amorphization of Na₆CoS₄. As shown in FIG. 17C, the cell was tested at 0.1 mV s⁻¹ in the range of 1.2 to 2.8 V (vs. Na⁺/Na) for two cycles. FIG. 17D shows the time-resolved Raman image recorded on the cathode material during cycling.

In addition to in-situ techniques, ex-situ analysis, such as TEM and X-ray photoelectron spectroscopy (XPS), of Na₆CoS₄ at different states of cycling was conducted to investigate the detailed product phase. As described earlier, based on the covalent nature of the Co—S bonds owing to the overlap of the Co 3d band with the S 2p bands, the removal of electrons/sodium from the structure would result in an oxidation of the sulfide anions. In the contour plot of the ED-XRD data in FIG. 17B, a set of dominant peaks of Na₆CoS₄ (PDF #86-1254) with strong intensity can be observed at the initial stage of the charge process. As the charge step proceeds, the diffraction peak intensity tends to weaken. The first peak of losing detectable intensity corresponds to the (301) plane of Na₆CoS₄, suggesting the desodiation begins with the removal of sodium from the NaS₄ tetrahedra. The next peak to lose intensity belongs to the (220) plane, indicating sodium removal from the octahedral site. At about 80% depth-of-charge, all the peaks of Na₆CoS₄, except the ones for (101) and (211) planes, completely vanish, suggesting the transformation of the MS₄ tetrahedral unit to MS₆ octahedra, which is prevalent in CoS.

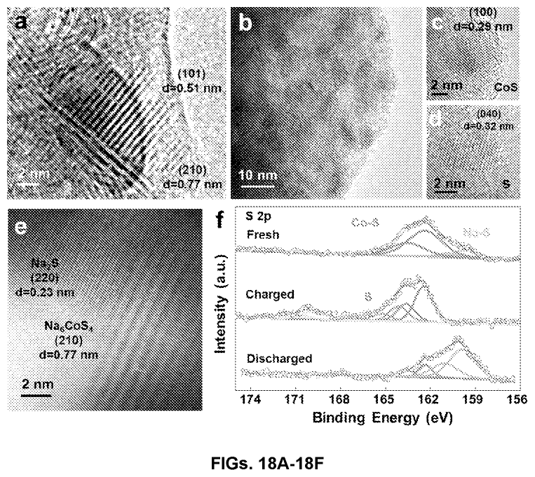

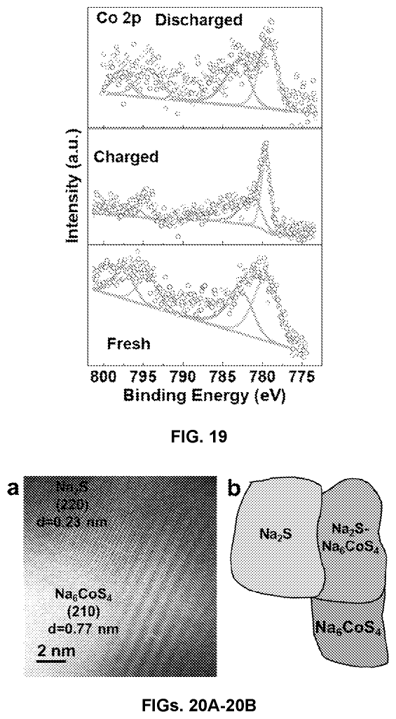

This loss of intensity is corroborated by the TEM images (FIG. 18), wherein the size of the primary Na₆CoS₄ particles (FIG. 18A) changed from several 100 nm size grains to 4-8 nm size grains (FIG. 18B-D). Additionally, TEM also shows 2-4 nm size domains of CoS and S wrapped in the carbon matrix, confirming the observation of CoS in ED-XRD. XPS was used to track the oxidation state changes through this process. The S 2p spectrum (FIG. 18F) of the fresh sample shows two sulfur contributions at 159.8 and 162.4 eV, corresponding to, respectively, the Na—S bonds and Co—S bonds. When the Na₆CoS₄@C was fully charged, the peaks in the S 2p spectrum showed a positive shift with two sulfur contributions at 162.5 and 164.1 eV, attributed, respectively, to the Co—S bonds and S—S bonds; this indicates the formation of sulfur and CoS as seen in the TEM and validates that the sulfide anions are oxidized to sulfur through anion redox. This also implies that there is little change in the oxidation state of Co. As shown in FIG. 19, the fresh Na₆CoS₄@C sample shows two Co 2p_{3/2} components at 779.5 and 782.9 eV, corresponding, respectively, to Co²⁺ and Co²⁺ satellites. After fully charging, only Co²⁺ and Co²⁺ satellites are observed, albeit with a positive shift of 0.5 eV, owing to the formation of CoS and its subsequent interaction with S.

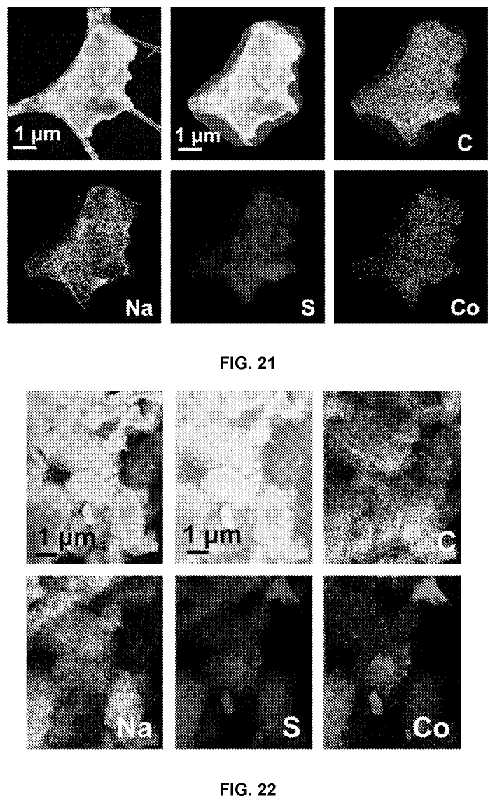

The discharge starts with the cathode having nanometer-sized domains of CoS and S. For this reason, it is hard to see any peaks in the ED-XRD. To resolve this issue, in-situ Raman spectroscopy, wherein the pristine Na₆CoS₄ can be seen in the 1,200 to 1,650 cm⁻¹ range, was used. While no peaks are observed in the charged state, during the reduction process, the intensity of the typical peaks of Na₆CoS₄ gradually becomes stronger. In addition, the peaks of Na₆CoS₄ become both broad and intense in the second cycle, suggesting the loss of long-range translational symmetry and implying the formation of nanosized Na₆CoS₄. TEM of the discharged cathode sheds light on both the morphology and identity of the cathode in the discharged state. The discharged cathode (FIG. 17E) contains a mosaic of 8-10 nm size grains of Na₂S and Na₆CoS₄ (FIG. 20). The elemental mapping images of the fresh and fully discharged samples in FIG. 21 and FIG. 22 suggest that Na and S along with Co are present. However, the presence of Na₂S and the broadening of peaks in the Raman spectra suggest that a small portion of the sulfur may be segregated during the first charge step, which converts back to Na₂S, while the sulfur close to CoS can become amorphous Na₆CoS₄₋ₓ (a-Na₆CoS₄). The loss of sulfur from the parent Na₆CoS₄ during the first cycle to yield Na₂S and the sulfur-deficient a-Na₆CoS₄ is also corroborated by the XPS data of the discharged cathode (FIG. 5f), showing a higher intensity for the Na—S peaks compared to Co—S, while the Co oxidation state remains 2+(FIG. 19). The formation of Na₂S and a-Na₆CoS₄ explains the differences in the voltage curve and the loss of some reversible capacity between the first and the second cycle.

Based on the evidence from the different materials characterization techniques, we deem the unique Na₆CoS₄ reaction pathway as described below:

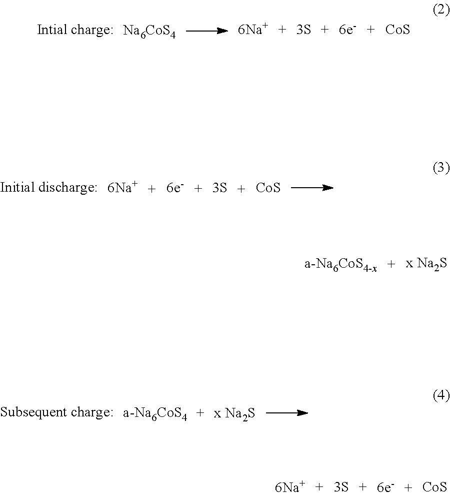

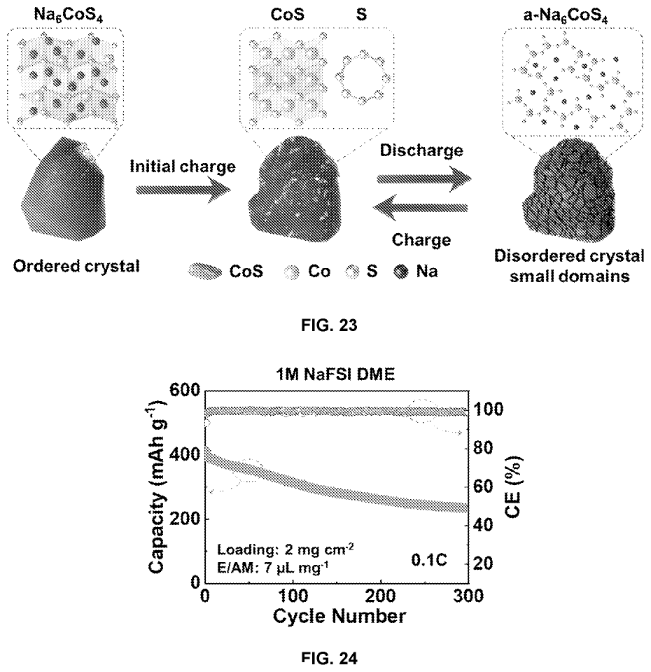

This reaction pathway has been schematically represented in FIG. 23. The class of Na₆CoS₄ displays a six-electron redox reaction. During the initial charge process, Na₆CoS₄ first transforms from a highly crystalline to an amorphous structure, mainly consisting of nanosized CoS and sulfur nanoparticles. Afterward, the conversion is highly reversible from amorphous a-CoS/S to a-Na₆CoS₄₋ₓ and some Na₂S particles with rich, small, disordered crystal domains.

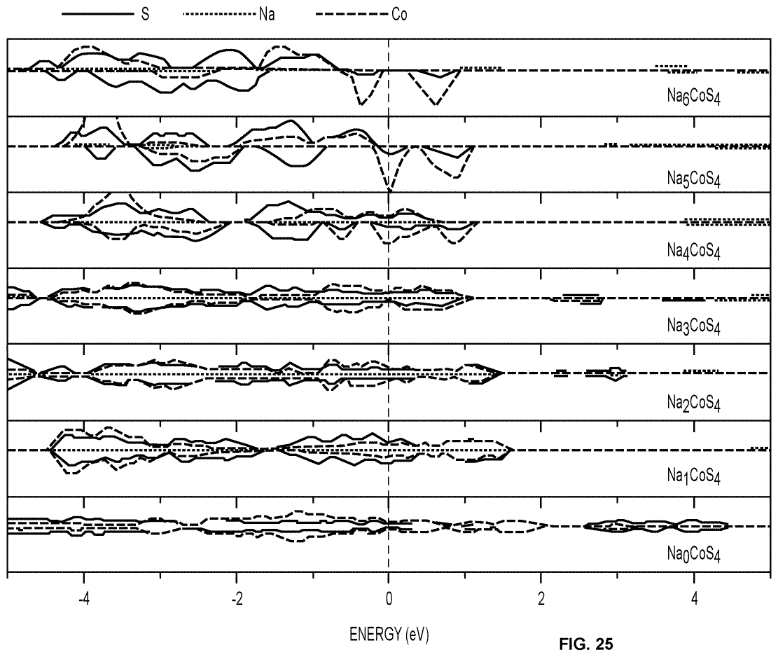

This anion-redox-based conversion reaction possesses several advantages. First, unlike conventional sodium-sulfur batteries, the Na₆CoS₄ cathode redox does not involve sodium polysulfide (NaPSs) formation and shuttling, overcoming the capacity decay challenges of conventional sulfur cathodes. Such a conclusion can be easily confirmed by the good cycling performance of Na₆CoS₄@C cathode in the conventional low-concentration electrolyte of 1 M NaFSI in DME, as shown in FIG. 24, compared to the few cycles lifespan observed in the literature for sulfur cathode in low-concentration electrolytes (15-17). Second, conductivity changes in the material through cycling were traced through the evolution of pDOS during the desodiation process, as shown in FIG. 25. Following the Na removal, there was a depletion of the Co 3d band and the S 3p band near the Fermi level, indicating the co-oxidation of both Co²⁺ and S₂⁻ during charge, resulting from the overlap of the Co^{2+/3+} and S²⁻: 2p bands and the strong hybridization and pinning of the Co: 3d and S: 2p orbitals. We also found that the conductivity of Na₆₋ₓCoS₄ becomes better during the Na extraction process due to the introduction of holes into the S²⁻:3p band, which is beneficial for electrode performance.

In summary, for the first time, a class of Na₆MS₄ (M=Mn, Fe, Co, and Zn) is shown to serve as cathode materials for Na-ion batteries. By selecting Na₆CoS₄ as a model system, a unique cathode chemistry was discovered. During the initial charge process, Na₆CoS₄ first transforms from a highly crystalline to an amorphous structure, mainly consisting of nanosized CoS and sulfur nanoparticles. Afterward, the conversion is highly reversible from amorphous a-CoS/S to a-Na₆CoS₄ particles with rich, small, disordered crystal domains. The six-electron redox reaction was realized through such a unique conversion pathway, whose theoretical capacity is 495 mAh g⁻¹. Finally, when we compare the theoretical energy of different classes of Na-cathodes, including polyanion, layered oxide, and Prussian blue analogs, as summarized in Table 2, the Na₆MS₄@C cathode family delivers the energy density of 926 Wh kg⁻¹.

### Example 2

Na₆CoS₄ was prepared similarly to Example 1. The obtained Na₆CoS₄, acetylene black, and polyvinylpyrrolidone are ground evenly in a mortar with a mass ratio of R (R=40:4:1) and then transferred to a 10 ml beaker, then an appropriate amount of acetonitrile is added, and stirring is performed to obtain a slurry.

The above-mentioned slurry is evenly applied on a substrate (the substrate is aluminum foil or carbon cloth), which is cut into discs with a diameter of 1.0 centimeters after vacuum drying to obtain the positive electrode plates.

2032 button batteries were prepared, and cycle testing was performed on Na₆CoS₄ prepared by the present invention.

The specific assembling steps were packaging a Na₆CoS₄ positive electrode plate, a separator, and a sodium sheet in a button battery shell and performing cycle testing. The electrolyte is NaFSI:DME:TTE (1:1.2:1) electrolyte.

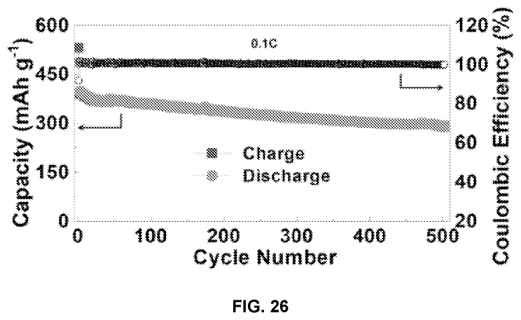

As shown in FIG. 26, a battery having Na₆CoS₄ as the positive electrode and the sodium sheet as the negative electrode exhibited an excellent cycle performance of more than 500 cycles under a current density of 0.2 A/g.

Additional 2032 button batteries were prepared, and rate testing was performed on the Na₆CoS₄ prepared by the present invention. The specific assembling steps included packaging a Na₆CoS₄ positive electrode plate, a separator, and a sodium sheet in a button battery shell and performing cycle testing. The electrolyte is NaFSI:DME:TTE (1:1.2:1) electrolyte.

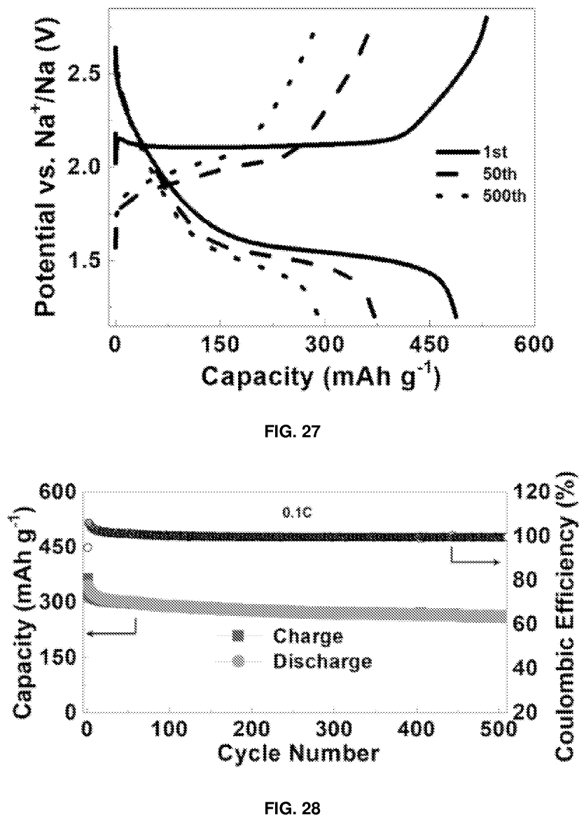

As shown in FIG. 27, the Na₆CoS₄ positive electrode material exhibited good capacity retention and a low charging and discharging voltage platform in the cycle process.

As shown in a previously presented FIG. 17A, the charging and discharging curve has both a platform and a slope, the platform represents the oxidation-reduction reaction, the slope represents the deintercalation reaction mechanism, and the reaction involved by Na₆CoS₄ is a deintercalation-redox composite reaction system.

### Example 3

In this example, Na₆FeS₄ was used as a cathode electrode material.

As shown in previously presented FIG. 8, the X-ray diffraction pattern of Na₆FeS₄, the upper peak is an experimental group, the lower peak is a comparison group, and it can be found that a material prepared by experiments corresponds to a standard material in peak position, indicating that the material is successfully prepared.

The obtained Na₆FeS₄, acetylene black, and polyvinylpyrrolidone are ground evenly in a mortar with a mass ratio of R (R=40:4:1) and then transferred to a 10 ml beaker, then an appropriate amount of acetonitrile is added, and stirring is performed to obtain a slurry. The above-mentioned slurry is evenly applied on the substrate, which is cut into discs with a diameter of 1.0 centimeter after vacuum drying to obtain the positive electrode plates.

2032 button batteries were prepared, and cycle testing was performed on Na₆FeS₄ prepared by the present invention. The specific assembling steps included packaging a Na₆FeS₄ positive electrode plate, a separator and a sodium sheet in a button battery shell and performing cycle testing. Among them, the electrolyte is a NaFSI:DME:TTE (1:1.2:1) electrolyte.

As shown in FIG. 28, a battery with Na₆FeS₄ as the positive electrode and the sodium sheet as the negative electrode exhibited excellent cycle performance of more than 500 cycles under a current density of 0.2 A/g.

2032 button batteries were prepared, and rate testing was performed on the Na₆FeS₄ prepared by the present invention. The specific assembling steps are packaging a Na₆FeS₄ positive electrode plate, a separator and a sodium sheet in a button battery shell and performing cycle testing. The electrolyte is NaFSI:DME:TTE (1:1.2:1) electrolyte.

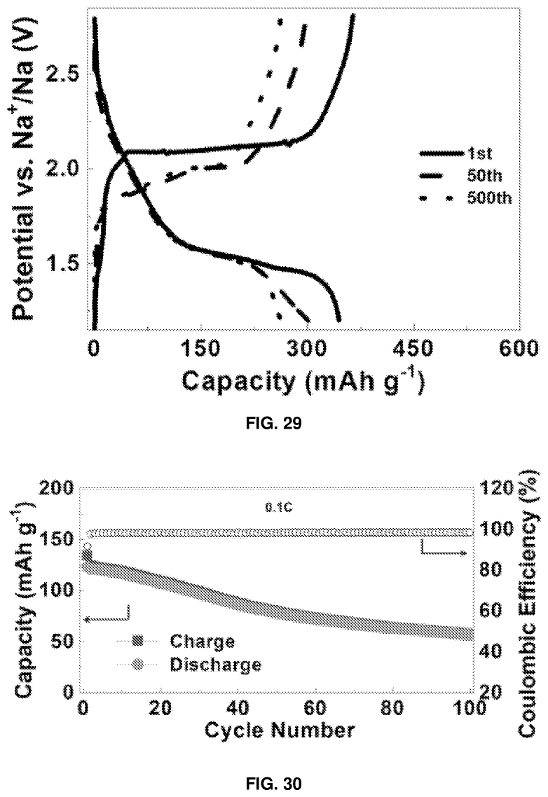

As shown in FIG. 29, it is shown in the figure that: the Na₆FeS₄ positive electrode material has good capacity retention and a low charging and discharging voltage platform in the cycle process.

### COMPARATIVE EXAMPLE

Here, an NFM (NaNi_{1/3}Fe_{1/3}Mn_{1/3}O₂) was used as a comparative cathode electrode.

The obtained NFM (NaNi_{1/3}Fe_{1/3}Mn_{1/3}O₂, classic sodium-ion positive electrode material), acetylene black, and polyvinylidene fluoride are ground evenly in a mortar with a mass ratio of R and then transferred into a 10 ml beaker, then an appropriate amount of N-methylpyrrolidone is added, and stirring is performed to form a slurry.

The above-mentioned slurry is evenly coated on the substrate (aluminum foil, carbon cloth), which is cut into discs with a diameter of 1.0 centimeter after vacuum drying to obtain the positive electrode plates.

2032 button batteries were prepared, and cycle testing was performed on NFM. The specific assembling steps included packaging an NFM positive electrode plate, a separator and a sodium sheet in a button battery shell and performing cycle testing. The electrolyte is NaFSI:DME:TTE (1:1.2:1) electrolyte.

As shown in FIG. 30, a battery with NFM as the positive electrode and the sodium sheet as the negative electrode has a low capacity and a cycle number smaller than 100 under a current density of 0.2 A/g.

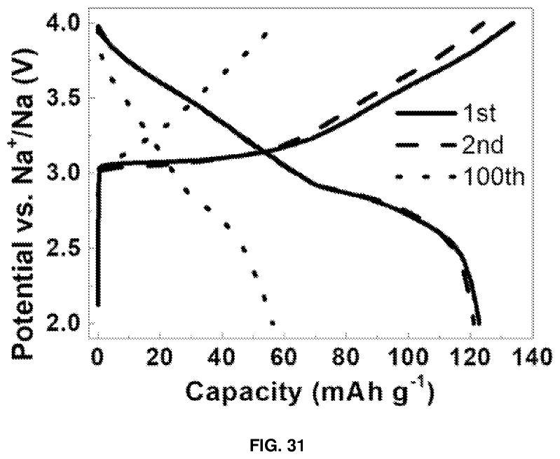

Additional 2032 button batteries were prepared, and rate testing was performed on the NFM prepared by the present invention. The specific assembling steps included packaging an NFM positive electrode plate, a separator and a sodium sheet in a button battery shell and performing cycle testing. The electrolyte is NaFSI:DME:TTE (1:1.2:1) electrolyte.

[As shown in FIG. 31, the NFM positive electrode material has a high voltage platform and a low-capacity retention rate in the cycle process.

Table 3 is obtained through Examples 2 and 3 and Comparative Example. It can be seen that the positive electrode material of the patent invention achieves at least a nearly 3-fold increase in the first-cycle discharging capacity of the sodium battery, and the cycle stability and the capacity retention rate are greatly improved:

TABLE 3

| | First-cycle | | Capacity |
|---|---|---|---|
| | discharging capacity | Cycle | retention |
| | (mAh g⁻¹) | number | rate |
| Example 2 | 487 | 500 | 73% |
| Example 3 | 344 | 500 | 76% |
| Comparative | 125 | 100 | 40% |
| Example | | | |

The devices, systems, and methods of the appended claims are not limited in scope by the specific devices, systems, and methods described herein, which are intended as illustrations of a few aspects of the claims. Any devices, systems, and functionally equivalent methods are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps are also intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, herein below are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### Exemplary Aspects

In view of the described processes and compositions, herein below are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

Example 1. A cathode electrode for a reversible battery comprising an active material comprising an alkali metal ion or alkaline-earth metal ion and at least one or more transition metal chalcogenides, and wherein active redox species comprise anions.

Example 2. The cathode electrode of any one of the examples herein, particularly Example 1, wherein the anion redox species comprise chalcogen anion.

Example 3. The cathode electrode of any one of the examples herein, particularly Examples 1-2, wherein the active material is crystalline.

Example 4. The cathode electrode of any one of the examples herein, particularly Examples 1-3, wherein the active material is represented by M¹M²X, wherein M¹ comprises Li, Na, K, or a combination thereof; wherein M² comprises at least one transition metal ion comprising Co, Fe, Mn, Ni, V, Ti, Cr, Cu, Zr, Nb, Ta, Mo, W, Pd, Pt, Re, Cd, or a combination thereof; wherein X comprises S, Se, Te, O, or a combination thereof; and wherein M¹, M², and X are present in a predetermined ratio.

Example 5. The cathode electrode of any one of the examples herein, particularly Example 4, wherein the active material further comprises Y and is represented by M¹M²XY, wherein Y comprises a halogen, and wherein M¹, M², X, and Y are present in a predetermined ratio.

Example 6. The cathode electrode of any one of the examples herein, particularly Examples 1-5, wherein the active material further comprises a dopant.

Example 7. The cathode electrode of any one of the examples herein, particularly Examples 4-6, wherein the M² further comprises a dopant comprising one or more of Mg, Ba, Ca, Sr, Al, B, Ga, Si, Ge, As, Zn, Sn, Sb, In, or any combination thereof.

Example 8. The cathode electrode of any one of the examples herein, particularly Examples 1-7, wherein the active material is represented by Mₐ¹M_{b}²X_{c}Y_{d}, wherein M¹ is Na, wherein 2≤a≤7, M² is one of Co, Fe, Mn, Ni, V, Ti, Cr, Cu, Zr, Nb, Ta, Mo, W, Pd, Pt, Re, Cd, or a combination thereof, wherein 0<b≤2; X is one or more of S, Se, Te, O, or a combination thereof, wherein 2<c≤5, and Y is a halogen, wherein 0≤d≤1.

Example 9. The cathode electrode of any one of the examples herein, particularly Example 8, wherein the M² further comprises one or more of Mg, Ba, Ca, Sr, Al, B, Ga, Si, Ge, As, Zn, Sn, Sb, In, or any combination thereof.

Example 10. The cathode electrode of any one of the examples herein, particularly Example 8 or 9, wherein the M² is Co, Fe, Mn, or a combination thereof.

Example 11. The cathode electrode of any one of the examples herein, particularly Examples 8-10, wherein X is S or Se or Te, O, or a combination thereof.

Example 12. The cathode electrode of any one of the examples herein, particularly Examples 8-11, wherein when d>0, Y is Cl, Br, I, F, or a combination thereof.

Example 13. The cathode electrode of any one of the examples herein, particularly Examples 1-12, wherein the active material comprises Na₆CoS₄.

Example 14. The cathode electrode of v Examples 1-13, wherein the active material comprises Na₆FeS₄.

Example 15. The cathode electrode of any one of the examples herein, particularly Examples 1-14, wherein the active material further comprises a conductive agent.

Example 16. The cathode electrode of any one of the examples herein, particularly Example 15, wherein the conductive agent comprises one or more of carbon black, carbon nanotubes, graphene, graphite, modified and unmodified carbon, conductive polymers, conductive oxides, conductive ceramics, or any combination thereof.

Example 17. The cathode electrode of any one of the examples herein, particularly Examples 1-16, wherein the active material further comprises a binder.

Example 18. A secondary battery comprising the cathode electrode of any one of the examples herein, particularly Examples 1-17.

Example 19. The secondary battery of any one of the examples herein, particularly Example 18, wherein the battery further comprises an anode electrode and an electrolyte.

Example 20. The secondary battery of any one of the examples herein, particularly Example 19, wherein the electrolyte is a liquid electrolyte comprising a salt and a solvent.

Example 21. The secondary battery of any one of the examples herein, particularly Example 20, wherein the salt comprises a cation that is a cation of alkali and/or alkaline-earth metal present in the active material.

Example 22. The secondary battery of any one of the examples herein, particularly Example 20 or 21, wherein the salt comprises one or more of sodium fluorophosphate (NaPF₆), sodium fluoroborate (NaBF₄), sodium tetraphenylborate (NaBPh₄), sodium bis(fluorosulfonyl)imide (NaFSI), sodium bis(trifluoromethanesulfonyl)imide (NaTFSI), sodium (fluorosulfonyl)(trifluoromethanesulfonyl)imide (NaFTFSI), sodium perchlorate (NaClO₄), sodium nitrate (NaNO₃), sodium 4,5-dicyano-2-(trifluoromethyl)imidazole (NaTDI), sodium 4,5-dicyano-2-(pentafluoromethyl)imidazole (NaPDI), and sodium difluorooxalato borate (NaDFOB), or any combination thereof.

Example 23. The secondary battery of any one of the examples herein, particularly Examples 20-22, wherein the solvent comprises one or more of ethylene carbonate (EC), 1,2-Dimethoxyethane (DME), propylene carbonate (PC), dimethyl carbonate (DMC), diethyl carbonate (DEC), 1,2-Dimethoxyethane (DME), fluoroethylene carbonate (FEC), tetrahydrofuran (THF), diethylene glycol dimethyl ether (Diglyme), triethylene glycol dimethyl ether (TDEM), tetraethylene glycol dimethyl ether (TEGDME), and vinylene carbonate (VC), Bis(2,2,2-trifluoroethyl) ether (BTFE), 1,1,2,2-tetrafluoroethyl 2,2,3,3-tetrafluoropropylether (TTE), tris(2,2,2-trilfuoroethyl) orthoformate (TFEO), trimethylphosphate (TMP), triethylphosphate (TEP), or any combination hereof.

Example 24. The secondary battery of any one of the examples herein, particularly Examples 20-23, wherein the salt is present in an amount of about 0.01 M to about 3 M.

Example 25. The secondary battery of any one of the examples herein, particularly Example 19, wherein the electrolyte is a solid electrolyte.

Example 26. The secondary battery of any one of the examples herein, particularly Examples 20-25, wherein the anode electrode comprises one or more metallic alkali and/or alkaline earth foils, alkali and/or alkaline earth powder, alkali and/or alkaline earth meshes, alkali and/or alkaline earth alloys, carbon materials, non-alkali and/or non-alkaline earth metal alloys, nonmetal alloys, compound materials, or any combination thereof.

Example 27. The secondary battery of any one of the examples herein, particularly Examples 19-26, wherein the anode electrode is a current collector for an alkali metal deposition during a plating step

Example 28. The secondary battery of any one of the examples herein, particularly Examples 18-27, wherein the alkali metal is sodium such that the secondary battery is a sodium-ion battery.

Example 29. The secondary battery of any one of the examples herein, particularly Example 28, wherein the anode electrode comprises an elemental or compound anode suitable for sodium-ion batteries.

Example 30. The secondary battery of any one of the examples herein, particularly Examples 18-29, wherein the secondary battery exhibits a specific capacity of about 100 mAh g⁻¹ to about 600 mAh g⁻¹ at a discharge rate of at least about 0.1 C.

Example 31. The secondary battery of any one of the examples herein, particularly Example 30, wherein the secondary battery exhibits a capacity retention of at least about 75% over at least about 200 cycles.

Example 32. The secondary battery of any one of the examples herein, particularly Examples 30-31, wherein the secondary battery exhibits a capacity retention of at least about 75% over at least about 500 cycles.

Example 33. The secondary battery of any one of the examples herein, particularly Examples 18-32, wherein the secondary battery exhibits coulombic efficiency of greater than about 95%.

Example 34. The secondary battery of any one of the examples herein, particularly Examples 18-33, wherein a cathode redox does not involve alkali metal polysulfide formation and/or shuttling.

Example 35. The secondary battery of any one of the examples herein, particularly Examples 18-34, wherein the battery is capable of operating in a temperature range of about −30° C. to about 60° C.

Example 36. A method of making a cathode electrode of any one of the examples herein, particularly Examples 1-17, wherein the method comprises: (a) forming a mixture comprising an alkali metal or an alkaline-earth metal, one or more transition metals, and a chalcogen-group element; (b) heating the mixture to form an active material represented by M¹M²X, wherein M¹ is an alkali metal ion or an alkali-earth metal ion, wherein M² comprises one or more transition metal ions, and wherein X comprises at least one chalcogen anion, and wherein M¹, M², and X are present in a predetermined ratio.

Example 37. The method of any one of the examples herein, particularly Example 36, wherein M¹ is Li, Na, K, or a combination thereof.

Example 38. The method of any one of the examples herein, particularly Example 36 or 37, wherein M² is Co, Fe, Mn, Ni, Al, B, V, Ti, Cr, Cu, Ga, Si, Ge, As, Zr, Nb, Ta, Mo, W, Pd, Pt, Re, Cd, or a combination thereof.

Example 39. The method of any one of the examples herein, particularly Examples 36-38, wherein X is an anion of S, Se, Te, O, or a combination thereof.

Example 40. The method of any one of the examples herein, particularly Examples 36-39, wherein the M² further comprises one or more of Mg, Ba, Ca, Sr, Al, B, Ga, Si, Ge, As, Zn, Sn, Sb, In or any combination thereof.

Example 41. The method of any one of the examples herein, particularly Examples 36-40, wherein the active material further comprises Y and is represented by M¹M²XY, wherein Y comprises a halogen, and wherein M¹, M², X, and Y are present in a predetermined ratio.

Example 42. The method of any one of the examples herein, particularly Example 41, wherein the active material is represented by Mₐ¹M_{b}²X_{c}Y_{d}, wherein M¹ is Na, wherein 2≤a≤7, M² is one of Co, Fe, Mn, Ni, V, Ti, Cr, Cu, Zr, Nb, Ta, Mo, W, Pd, Pt, Re, Cd, or a combination thereof, wherein 0<b≤2; X is one or more of S, Se, Te, O, or a combination thereof, wherein 2<c≤5, and Y is a halogen, wherein 0≤d≤1.

Example 43. The method of any one of the examples herein, particularly Examples 36-42, wherein at least one of the alkali metal, the alkaline-earth metal, the one or more transition metals, and the chalcogen-group element in the mixture are present as an ion.

Example 44. The method of any one of the examples herein, particularly Examples 36-42, wherein at least one of the alkali metal, the alkaline-earth metal, the one or more transition metals, and the chalcogen-group element in the mixture are present in zero valence.

Example 45. The method of any one of the examples herein, particularly Examples 36-43, wherein the mixture is formed in a first solvent.

Example 46. The method of any one of the examples herein, particularly Example 45, wherein the first solvent is an aqueous solution, an organic solvent, or a combination thereof.

Example 47. The method of any one of the examples herein, particularly Examples 36-46, wherein the mixture further comprises a reducing or an oxidizing agent.

Example 48. The method of any one of the examples herein, particularly Examples 36-47, wherein the mixture comprises a reducing agent comprising carbon.

Example 49. The method of any one of the examples herein, particularly Examples 36-48, wherein the mixture further comprises a conductive agent, a binder, or a combination thereof.

Example 50. The method of any one of the examples herein, particularly Examples 36-49, wherein the heating of the mixture performed at a temperature of 500° C.-1000° C. in one or more heating steps.

Example 51. The method of any one of the examples herein, particularly Examples 36-50, further comprising forming a slurry of the active material and a binder in a second solvent.

Example 52. The method of any one of the examples herein, particularly Example 51, wherein the second solvent comprises one or more organic solvents.

Example 53. The method of any one of the examples herein, particularly Example 51 or 52, wherein the slurry is disposed on a substrate and the second solvent is substantially removed.

Example 54. A method comprising: providing the cathode electrode of any one of the examples herein, particularly Examples 1-17; providing an anode electrode; providing an electrolyte; and providing a separator; forming the secondary battery of any one of the examples herein, particularly Examples 18-35.

### REFERENCES

1. 1. Manthiram, A. A reflection on lithium-ion battery cathode chemistry. Nat. Commun. 11, 1550 (2020).
2. Zheng, J. et al. Electrolyte additive enabled fast charging and stable cycling lithium metal batteries. Nat. Energy. 2, 17012 (2017).
3. Jin, C. et al. Rejuvenating dead lithium supply in lithium metal anodes by iodine redox. Nat. Energy. 6, 378-387 (2021).
4. Li, Y. et al. Interfacial engineering to achieve an energy density of over 200 Wh kg⁻¹ in sodium batteries. Nat. Energy. 7, 511-519 (2022).
5. Wang, J. et al. Fire-extinguishing organic electrolytes for safe batteries. Nat. Energy. 3, 22-29 (2018).
6. Xu, Z. et al. Tailoring sodium intercalation in graphite for high energy and power sodium ion batteries. Nat. Commun. 10, 2598 (2019).
7. Saha, S. et al. Exploring the bottlenecks of anionic redox in Li-rich layered sulfides. Nat. Energy. 4, 977-987 (2019).
8. Shadike, Z. et al. Antisite occupation induced single anionic redox chemistry and structural stabilization of layered sodium chromium sulfide. Nat. Commun. 8, (2017).
9. Xu, H., Guo, S. & Zhou, H. Review on anionic redox in sodium-ion batteries. Journal of Materials Chemistry. A, Materials for Energy and Sustainability. 7, 23662-23678 (2019).
10. Huang, Y. et al. Na₆MQ₄ (M=Zn, Cd; Q=S, Se): Promising New Ternary Infrared Nonlinear Optical Materials. Chemistry—a European Journal. 27, 6538-6544 (2021).
11. Bronger, W., Böhmer, M. & Müller, P. Magnetic properties of the ternary sulfide Na₆MnS₄. J. Alloy. Compd. 338, 116-120 (2002).
12. Bronger, W., Bomba, C. & Koelman, W. Über die Magnetischen Eigenschaften der Cobaltate Na₆CoS₄, Na₆COSe₄ und K₆CoS₄. Zeitschrift Für Anorganische Und Allgemeine Chemie. 621, 409-411 (1995).
13. Bronger, W., Balk-Hardtdegen, H. & Ruschewitz, U. Darstellung, Struktur und magnetische Eigenschaften der Natriumeisenchalkogenide Na₆FeS₄ und Na₆FeSe₄. Zeitschrift Für Anorganische Und Allgemeine Chemie. 616, 14-18 (1992).
14. Su, L. et al. Tailoring Electrode-Electrolyte Interfaces in Lithium-Ion Batteries Using Molecularly Engineered Functional Polymers. Acs Appl. Mater. Interfaces. 13, 9919-9931 (2021).
15. He, J., Bhargav, A., Shin, W. & Manthiram, A. Stable Dendrite-Free Sodium-Sulfur Batteries Enabled by a Localized High-Concentration Electrolyte. J. Am. Chem. Soc. 143, 20241-20248 (2021).
16. Burke, K., Ernzerhof, M. & Perdew, J. P. Generalized Gradient Approximation Made Simple. Phys. Rev. Lett. 77, 3865-3868 (1996).
17. Joubert, D. & Kresse, G. From ultrasoft pseudopotentials to the projector augmented-wave method. Phys. Rev. B. 59, 1758-1775 (1999).
R1. Wang, L. et al. A Superior Low-Cost Cathode for a Na-Ion Battery. Angewandte Chemie International Edition. 52:1964-1967 (2013).
R2. Wang, Y. et al. Pillar-beam structures prevent layered cathode materials from destructive phase transitions. Nat. Commun. 12 (2021).
R3. Gao, H. & Goodenough, J. B. An Aqueous Symmetric Sodium-Ion Battery with NASICON-Structured Na₃MnTi(PO₄)₃. Angewandte Chemie International Edition. 55: 12768-12772 (2016).
R4. Li, Q. et al. A Superlattice-Stabilized Layered Oxide Cathode for Sodium-Ion Batteries. Adv. Mater. 32: 1907936 (2020).
R5. Zhang, J. et al. A Novel NASICON-Type Na₄MnCr(PO₄)₃ Demonstrating the Energy Density Record of Phosphate Cathodes for Sodium-Ion Batteries. Adv. Mater. 32: 1906348 (2020).
R6. Gu, Z. Y. et al. An Advanced High-Entropy Fluorophosphate Cathode for Sodium-Ion Batteries with Increased Working Voltage and Energy Density. Adv. Mater. 34: 2110108 (2022).
R7. Peng, B. et al. Unusual Site-Selective Doping in Layered Cathode Strengthens Electrostatic Cohesion of Alkali-Metal Layer for Practicable Sodium-Ion Full Cell. Adv. Mater. 34: 2103210 (2022).
R8. Chae, M. S. et al. Vacancy-Driven High Rate Capabilities in Calcium-Doped Na_{0.4}MnO₂ Cathodes for Aqueous Sodium-Ion Batteries. Adv. Energy Mater. 10: 2002077 (2020).
R9. Xiao, Y. et al. A Stable Layered Oxide Cathode Material for High-Performance Sodium-Ion Battery. Adv. Energy Mater. 9: 1803978 (2019).
R10. Yao, L. et al. High-Entropy and Superstructure-Stabilized Layered Oxide Cathodes for Sodium-Ion Batteries. Adv. Energy Mater. 12: 2201989 (2022).
R11. Ghosh, S. et al. High Capacity and High-Rate NASICON-Na_{3.75}V_{1.25}Mn_{0.75}(PO₄)₃ Cathode for Na-Ion Batteries via Modulating Electronic and Crystal Structures. Adv. Energy Mater. 10: 1902918 (2019).
R12. Zhang, W. et al. Rationally Designed Sodium Chromium Vanadium Phosphate Cathodes with Multi-Electron Reaction for Fast-Charging Sodium-Ion Batteries. Adv. Energy Mater. 12: 2201065 (2022).
R13. Choi, J. U. et al. Mn-Rich P′2-Na_{0.67}[Ni_{0.1}Fe_{0.1}Mn_{0.8}]O₂ as High-Energy-Density and Long-Life Cathode Material for Sodium-Ion Batteries. Adv. Energy Mater. 10: 2001346 (2020).
R14. Gu, Z. Y. et al. High-ionicity fluorophosphate lattice via aliovalent substitution as advanced cathode materials in sodium-ion batteries. InfoMat. 3: 694-704 (2021).
R15. Lamb, J. & Manthiram, A. Stable Sodium-Based Batteries with Advanced Electrolytes and Layered-Oxide Cathodes. ACS Appl. Mater. Interfaces. 14: 28865-28872 (2022).
R16. Liu, Q. et al. Multiangular Rod-Shaped Na_{0.44}MnO₂ as Cathode Materials with High Rate and Long Life for Sodium-Ion Batteries. ACS Appl. Mater. Interfaces. 9: 3644-3652 (2017).
R17. Bhange, D. S. et al. Honeycomb-layer structured Na₃Ni₂BiO₆ as a high voltage and long life cathode material for sodium-ion batteries. Journal of materials chemistry. A, Materials for energy and sustainability. 5: 1300-1310 (2017).
R18. Doyle, R. L., Godwin, I. J., Brandon, M. P. & Lyons, M. E. Redox and electrochemical water splitting catalytic properties of hydrated metal oxide modified electrodes. Phys. Chem. Chem. Phys. 15:13737-83 (2013).
R19. Shanmugam, R. & Lai, W. Na_{2/3}Ni_{1/3}Ti_{2/3}O₂: “Bi-Functional” Electrode Materials for Na-Ion Batteries. ECS Electrochemistry Letters. 3: A23-A25 (2014).
R20. Wang, Y. et al. P2-Na_{0.6}[Cr_{0.6}Ti_{0.4}]O₂ cation-disordered electrode for high-rate symmetric rechargeable sodium-ion batteries. Nat. Commun. 6 (2015).
R21. Guo, S. et al. A High-Voltage and Ultralong-Life Sodium Full Cell for Stationary Energy Storage. Angewandte Chemie International Edition. 54:11701-11705 (2015).
R22. de la Llave, E. et al. Improving Energy Density and Structural Stability of Manganese Oxide Cathodes for Na-Ion Batteries by Structural Lithium Substitution. Chem. Mat. 28: 9064-9076 (2016).
R23. Zhang, J. et al. Graphene-Scaffolded Na₃V₂(PO₄)₃ Microsphere Cathode with High Rate Capability and Cycling Stability for Sodium Ion Batteries. ACS Appl. Mater. Interfaces. 9: 7177-7184 (2017).
R24. Shi, W. et al. Low-Strain Reticular Sodium Manganese Oxide as an Ultrastable Cathode for Sodium-Ion Batteries. ACS Appl. Mater. Interfaces. 12: 14174-14184 (2020).
R25. Shen, B. et al. Sodium-Rich Ferric Pyrophosphate Cathode for Stationary Room-Temperature Sodium-Ion Batteries. ACS Appl. Mater. Interfaces. 10: 502-508 (2018).
R26. Xu, H. et al. Sodium Alginate Enabled Advanced Layered Manganese-Based Cathode for Sodium-Ion Batteries. ACS Appl. Mater. Interfaces. 11: 26817-26823 (2019).
R27. Zhou, Y. et al. Air-Stable and High-Voltage Layered P3-Type Cathode for Sodium-Ion Full Battery. ACS Appl. Mater. Interfaces. 11: 24184-24191 (2019).
R28. Tang, M. et al. Spinel-Layered Intergrowth Composite Cathodes for Sodium-Ion Batteries. ACS Appl. Mater. Interfaces. 12: 45997-46004 (2020).
R29. Zhong, X. et al. Carbon-Coated Na₃V₂(PO₄)₃ Anchored on Freestanding Graphite Foam for High-Performance Sodium-Ion Cathodes. ACS Appl. Mater. Interfaces. 8: 32360-32365 (2016).
R30. Chang, W. et al. Freestanding Na₃V₂O₂(PO₄)₂F/Graphene Aerogels as High-Performance Cathodes of Sodium-Ion Full Batteries. ACS Appl. Mater. Interfaces. 12: 41419-41428 (2020).
R31. Kalluri, S. et al. Electrospun P2-type Na_{2/3}(Fe_{1/2}Mn_{1/2})O₂ Hierarchical Nanofibers as Cathode Material for Sodium-Ion Batteries. ACS Appl. Mater. Interfaces. 6: 8953-8958 (2014).
R32. Zhan, R. et al. High-Rate and Long-Life Sodium-Ion Batteries Based on Sponge-like Three-Dimensional Porous Na-Rich Ferric Pyrophosphate Cathode Material. ACS Appl. Mater. Interfaces. 11: 5107-5113 (2019).
R33. Yang, A. et al. High-Rate-Capacity Cathode Based on Zn-Doped and Carbonized Polyacrylonitrile-Coated Na₄MnV(PO₄)₃ for Sodium-Ion Batteries. ACS Appl. Mater. Interfaces. 15: 22132-22141 (2023).
R34. Zhou, C. et al. Co-Substitution Enhances the Rate Capability and Stabilizes the Cyclic Performance of O3-Type Cathode NaNi_{0.45-x}Mn_{0.25}Ti_{0.3}CoₓO₂ for Sodium-Ion Storage at High Voltage. ACS Appl. Mater. Interfaces. 11: 7906-7913 (2019).
R35. Deng, X. et al. A Green Route to a Na₂FePO₄F-Based Cathode for Sodium Ion Batteries of High Rate and Long Cycling Life. ACS Appl. Mater. Interfaces. 9: 16280-16287 (2017).
R36. Chen, C. et al. Core-Shell Layered Oxide Cathode for High-Performance Sodium-Ion Batteries. ACS Appl. Mater. Interfaces. 12: 7144-7152 (2020).
R37. Yu, L. et al. O3-Type Na_{0.95}Ni_{0.40}Fe_{0.15}Mn_{0.3}Ti_{0.15}O₂ Cathode Materials with Enhanced Storage Stability for High-Energy Na-Ion Batteries. ACS Appl. Mater. Interfaces. 15: 23236-23245 (2023).
R38. Wang, Q. et al. P2-Type Layered Na_{0.75}Ni_{1/3}Ru_{1/6}Mn_{1/2}O₂ Cathode Material with Excellent Rate Performance for Sodium-Ion Batteries. ACS Appl. Mater. Interfaces. 12: 39056-39062 (2020).
R39. Zhou, Y. et al. A P2/P3 composite layered cathode for high-performance Na-ion full batteries. Nano Energy. 55: 143-150 (2019).
R40. Zhang, Q. et al. Controllable construction of 3D-skeleton-carbon coated Na₃V₂(PO₄)₃ for high-performance sodium ion battery cathode. Nano Energy. 20: 11-19 (2016).
R41. Mu, L. et al. Prototype Sodium-Ion Batteries Using an Air-Stable and Co/Ni-Free O3-Layered Metal Oxide Cathode. Adv. Mater. 27: 6928-6933 (2015).
R42. Hwang, J. et al. Radially aligned hierarchical columnar structure as a cathode material for high energy density sodium-ion batteries. Nat. Commun. 6 (2015).
R43. Kim, J. et al. Unexpected discovery of low-cost maricite NaFePO₄ as a high-performance electrode for Na-ion batteries. Energy Environ. Sci. 8: 540-545 (2015).
R44. Chen, M. et al. Development and Investigation of a NASICON-Type High-Voltage Cathode Material for High-Power Sodium-Ion Batteries. Angewandte Chemie International Edition. 59: 2449-2456 (2020).
R45. Song, W. et al. Exploration of ion migration mechanism and diffusion capability for Na₃V₂(PO₄)₂F₃ cathode utilized in rechargeable sodium-ion batteries. J. Power Sources. 256: 258-263 (2014).
R46. Kim, H. et al. New Iron-Based Mixed-Polyanion Cathodes for Lithium and Sodium Rechargeable Batteries: Combined First Principles Calculations and Experimental Study. J. Am. Chem. Soc. 134:10369-10372 (2012).
R47. Wang, M. Y. et al. Isostructural and Multivalent Anion Substitution toward Improved Phosphate Cathode Materials for Sodium-Ion Batteries. Small. 16: 1907645 (2020).
R48. Xie, B. et al. Achieving long-life Prussian blue analogue cathode for Na-ion batteries via triple-cation lattice substitution and coordinated water capture. Nano Energy. 61: 201-210 (2019).
R49. Tang, X. et al. Hierarchical sodium-rich Prussian blue hollow nanospheres as high-performance cathode for sodium-ion batteries. Nano Res. 11: 3979-3990 (2018).
R50. Wang, L. et al. Rhombohedral Prussian White as Cathode for Rechargeable Sodium-Ion Batteries. J. Am. Chem. Soc. 137: 2548-2554 (2015).
R51. Mortemard De Boisse, B. et al. Intermediate honeycomb ordering to trigger oxygen redox chemistry in layered battery electrode. Nat. Commun. 7 (2016).
R52. Wang, W. et al. Reversible structural evolution of sodium-rich rhombohedral Prussian blue for sodium-ion batteries. Nat. Commun. 11 (2020).

1. A cathode electrode for a reversible battery comprising an active material comprising an alkali metal ion or alkaline-earth metal ion and at least one or more transition metal chalcogenides, wherein active redox species comprise anions, and wherein the active material is crystalline.

2. (canceled)

3. (canceled)

4. The cathode electrode of claim 1, wherein the active material is represented by M¹M²X,
wherein M¹ comprises Li, Na, K, or a combination thereof;
wherein M² comprises
at least one transition metal ion comprising Co, Fe, Mn, Ni, V, Ti, Cr, Cu, Zr, Nb, Ta, Mo, W, Pd, Pt, Re, Cd, or a combination thereof;
wherein X comprises S, Se, Te, O, or a combination thereof;
and wherein M¹, M², and X are present in a predetermined ratio.

5. The cathode electrode of claim 4, wherein the active material further comprises Y and is represented by M¹M²XY,
wherein Y comprises a halogen and wherein M¹, M², X, and Y are present in a predetermined ratio.

6. (canceled)

7. The cathode electrode of claim 4, wherein the M² further comprises a dopant comprising one or more of Mg, Ba, Ca, Sr, Al, B, Ga, Si, Ge, As, Zn, Sn, Sb, In, or any combination thereof.

8. The cathode electrode of claim 1, wherein the active material is represented by Mₐ¹M_{b}²X_{c}Y_{d}, wherein M¹ is Na, wherein 2≤a≤7, M² is one of Co, Fe, Mn, Ni, V, Ti, Cr, Cu, Zr, Nb, Ta, Mo, W, Pd, Pt, Re, Cd, or a combination thereof, wherein 0<b≤2; X is one or more of S, Se, Te, O, or a combination thereof, wherein 2<c≤5, and Y is a halogen, wherein 0≤d≤1, and wherein the M² further comprises one or more of Mg, Ba, Ca, Sr, Al, B, Ga, Si, Ge, As, Zn, Sn, Sb, In, or any combination thereof.

9. (canceled)

10. (canceled)

11. (canceled)

12. The cathode electrode of claim 8, wherein when d>0, Y is Cl, Br, I, F, or a combination thereof.

13. (canceled)

14. (canceled)

15. The cathode electrode of claim 1, wherein the active material further comprises a conductive agent comprising one or more of carbon black, carbon nanotubes, graphene, graphite, modified and unmodified carbon, conductive polymers, conductive oxides, conductive ceramics, or any combination thereof and/or a binder.

16. (canceled)

17. (canceled)

18. A secondary battery comprising the cathode electrode of claim 1, an anode electrode, and an electrolyte.

19. (canceled)

20. The secondary battery of claim 18, wherein the electrolyte is:
a) a liquid electrolyte comprising a salt and a solvent, wherein the salt comprises a cation that is a cation of alkali and/or alkaline-earth metal present in the active material, and wherein the salt is present in an amount of about 0.01 M to about 3 M; or
b) a solid electrolyte.

21. (canceled)

22. (canceled)

23. (canceled)

24. (canceled)

25. (canceled)

26. The secondary battery of claim 18, wherein the anode electrode comprises one or more metallic alkali and/or alkaline earth foils, alkali and/or alkaline earth powder, alkali and/or alkaline earth meshes, alkali and/or alkaline earth alloys, carbon materials, non-alkali and/or non-alkaline earth metal alloys, nonmetal alloys, compound materials, or any combination thereof or wherein the anode electrode is a current collector for an alkali metal deposition during a plating step.

27. (canceled)

28. (canceled)

29. (canceled)

30. The secondary battery of claim 18, wherein the secondary battery exhibits
a) a specific capacity of about 100 mAh g⁻¹ to about 600 mAh g⁻¹ at a discharge rate of at least about 0.1 C and/or
b) a capacity retention of at least about 75% over at least about 200 cycles; and/or
c) a coulombic efficiency of greater than about 95%.

31. (canceled)

32. (canceled)

33. (canceled)

34. (canceled)

35. (canceled)

36. A method of making a cathode electrode of claim 1, wherein the method comprises:
a. forming a mixture comprising an alkali metal or an alkaline-earth metal, one or more transition metals, and a chalcogen-group element;
b. heating the mixture to form an active material represented by M¹M²X,
wherein M¹ is an alkali metal ion or an alkali-earth metal ion,
wherein M² comprises one or more transition metal ions; and wherein X comprises at least one chalcogen anion, and wherein M¹, M², and X are present in a predetermined ratio;
wherein the heating of the mixture is performed at a temperature of 500° C.-1000° C. in one or more heating steps.

37. The method of claim 36, wherein M¹ is Li, Na, K, or a combination thereof; wherein M² is Co, Fe, Mn, Ni, Al, B, V, Ti, Cr, Cu, Ga, Si, Ge, As, Zr, Nb, Ta, Mo, W, Pd, Pt, Re, Cd, or a combination thereof; wherein X is an anion of S, Se, Te, O, or a combination thereof

38. (canceled)

39. (canceled)

40. The method of claim 37, wherein the M² further comprises one or more of Mg, Ba, Ca, Sr, Al, B, Ga, Si, Ge, As, Zn, Sn, Sb, In, or any combination thereof.

41. The method of claim 36, wherein the active material further comprises Y and is represented by M¹M²XY, wherein Y comprises a halogen, and wherein M¹, M², X, and Y are present in a predetermined ratio.

42. The method of claim 41, wherein the active material is represented by Mₐ¹M_{b}²X_{c}Y_{d}, wherein M¹ is Na, wherein 2≤a≤7, M² is one of Co, Fe, Mn, Ni, V, Ti, Cr, Cu, Zr, Nb, Ta, Mo, W, Pd, Pt, Re, Cd, or a combination thereof, wherein 0<b≤2; X is one or more of S, Se, Te, O, or a combination thereof, wherein 2<c≤5, and Y is a halogen, wherein 0 d 1.

43. The method of claim 36, wherein at least one of the alkali metal, alkaline-earth metal, the one or more transition metals, and the chalcogen-group element in the mixture are present as an ion or, wherein at least one of the alkali metal, alkaline-earth metal, the one or more transition metals, and the chalcogen-group element in the mixture are present in zero valence.

44. (canceled)

45. The method of claim 36, wherein the mixture is formed in a first solvent, wherein the first solvent is an aqueous solution, an organic solvent, or a combination thereof.

46. (canceled)

47. The method of claim 36, wherein the mixture further comprises a reducing or an oxidating agent, a conductive agent, a binder, or a combination thereof.

48. (canceled)

49. (canceled)

50. (canceled)

51. The method of claim 36, further comprising forming a slurry of the active material and a binder in a second solvent, wherein the second solvent comprises one or more organic solvents, and wherein the slurry is disposed on a substrate and the second solvent is substantially removed.

52. (canceled)

53. (canceled)

54. (canceled)
